(19) United States
(12) Patent Application Publication
(10) Pub. No.: US 2016/0078393 A1
(43) Pub. Date: Mar. 17, 2016

(54) METHOD AND SYSTEM FOR AUTOMATING THE ACCOUNTABILITY OF SERVICE PROFESSIONALS VIA CONSUMER EDUCATION AND RATING

(71) Applicant: David Michonski, Greenwich, CT (US)

(72) Inventor: David Michonski, Greenwich, CT (US)

(21) Appl. No.: 14/856,505

(22) Filed: Sep. 16, 2015

Related U.S. Application Data
(60) Provisional application No. 62/051,908, filed on Sep. 17, 2014.
(60) Provisional application No. 62/139,704, filed on Mar. 28, 2015.

(51) Int. Cl. G06Q 10/06

(52) U.S. Cl. CPC G06Q 10/063114; G06Q 10/06393

(57) ABSTRACT

Apparatus 510 assists in regulating the quality of services of providers. A server computer 512 comprises a processing unit 514 and a computer-readable medium which stores a task database 516, a time goal database 518, a job database 520, an actual task time database 522, a task weight database 524, an interim task grade database 526, and a grading algorithm 528 responsive to information in the time goal database to generate interim grades which are stored in interim task grade database 526. The actual task time database 522 and the task weight database 524, together with the task time goal database 518 drive the grading algorithm to generate cumulative grades which are stored in a system overall cumulative grade database 530. A plurality of provider personal computing devices receive prompts from a prompting algorithm. Provider personal computing devices are adapted to send task time completion data to the actual task time database. A plurality of client personal computing devices transmit and receive interim and final task grade database information for a particular job.

### CROSS REFERENCE TO RELATED APPLICATIONS

This application claims the priority benefit of U.S. Provisional Application No. 62/051,908 filed Sep. 17, 2014, and U.S. Provisional Application No. 62/139,704 filed Mar. 28, 2014 the disclosures and claims of which are hereby incorporated by reference thereto.

### TECHNICAL FIELD

The invention relates to a computer system and method for educating consumers and educating and objectively rating service professionals based on industry best practices presented in a user-friendly format via the Internet.

### STATEMENT REGARDING FEDERALLY SPONSORED RESEARCH OR DEVELOPMENT

(Not applicable)

### BACKGROUND OF THE INVENTION

Over the past decade, people have turned more and more to the Internet to educate themselves in a particular area of interest, from mastering a new hobby to obtaining a college degree. People are now able to attend college courses online at most major universities as well as obtain their degree entirely without ever leaving their home. Likewise, service professionals are able to continue their education through continuing education classes, which are offered online. For example, lawyers are able to take continuing legal education (CLE) classes over the Internet to satisfy their CLE requirements for continued bar membership. Likewise, real estate professionals are able to view webinars and attend classes online in order to become licensed real estate agents. Further, people can educate themselves on almost any topic they wish through online journals, periodicals, how-to websites, blogs, etc.

However, in accordance with the invention, the applicant has come to recognize that a major gap in online education systems and methods is their inability to enable individuals to learn while practicing in the real world and interacting with others, and further, in accordance with the invention, that such inability can be remedied in accordance with the novel and unobvious methods and systems detailed in this specification. Thus, there exists a need to provide a website that educates a person in real-time, while that person is actually performing the task(s) being taught.

In addition to education, people now rely on the Internet to search for the best service professional in their geographic area. People search the Internet for real estate agents, doctors, lawyers, plumbers, mechanics, etc. and rely on rating websites to select the best service professional in their area. For example, many use the Internet to look for a lawyer, relying on websites such as superlawyers®.com, yelp®.com, and yellowpages.com.

However, today's rating sites only provide a user with mostly subjective reviews of service professionals. For instance, yelp®.com relies on the subjective input of Internet users to review and rate a service professional based on the Internet user's personal experience and opinion. Similarly, superlawyers®.com relies on the opinion of peers and independent research done by the publication. There does not currently exist a rating website that uses a set of objective standards based upon industry best practices that are set by the industry itself and consumers to provide a grade to a service professional.

Furthermore, today's rating sites do not provide a consumer with the adequate knowledge to rate a service professional. For example, when buying or selling a home, consumers not only make one of the largest purchases of their lifetime, but they also pay one of the largest consumer service provider fees, an average of $15,000 in the United States. However, despite such a large fee, most home sellers and buyers have “no” knowledge of what their real estate agent is supposed to do to earn such a large fee.

Currently, the sales and buying process is usually based on trust in someone who is often, if not almost always, unknown to the consumer. In a study conducted by the Massachusetts Association of Realtors and confirmed by the National Association of Realtors and brokerage managers, it was found that the number one complaint consumers have with real estate agents is that the agent does not communicate to consumers what the process is, where they are in the process, and whether the agent has done everything that should be done to sell a home or get a buyer or renter the best price.

In addition, managers and broker/owners of offices or companies who have an independent contractor relationship (versus an employee relationship) with a service professional have less control over those service professionals. As a result, a manager is limited in his/her ability to ascertain whether the service professional is following the best standard of practice for the consumer.

Today, educational websites and rating websites remain separate and distinct from one another. Yet the merging of these two systems offers synergies which are exploited in accordance with the methods of the present invention which offers a singular website that simultaneously educates a service professional in a desired field, objectively grades that service professional, and provides that grade and education to consumers and professionals as a means to help them find a suitable service professional in a desired area of expertise.

Therefore, a need exists for such a singular system that educates a service professional based on industry best practices and then provides a grade based on those objective best practices while also simultaneously keeping a consumer and/or service professional manager abreast of all the steps a service professional should be and is following in an easy, user-friendly format.

### SUMMARY OF THE INVENTION

The present invention provides technology for automating the accountability of service professionals, promoting service provider/consumer communications, creating a consumer satisfaction measurement system and providing a service provider management system. The grade, however, is not based upon after-the-fact, subjective third party reviews that are often manipulated by service providers.

The inventive system bases its grade on steps and actions grounded in the industry's own recommended objective best practices. It also provides a grade during the service process in addition to after a service is completed. Because it educates both the service provider and the consumer with essential steps and actions the industry recommends to be done by the service provider to achieve excellent results, it empowers both consumers and service providers with specific, daily knowledge of the service process. It thus, not only provides ongoing and final objective grades and automates accountability, but it also empowers consumers with vital information and educates service providers on a daily basis.

For service providers the present invention offers easy-to-follow, step-by-step instruction and guidance on an industry's proven best practices. The result is a far greater chance of outstanding service for consumers.

With the present invention service providers also enjoy a significant shortening of the time and cost of educating and training themselves or their personnel. New entrants into a service industry are provided with a means of quickly entering the business and excelling, saving significant time normally spent in training and gaining experience.

With the present invention managers of service providers can now efficiently oversee a large sales or service force, reducing management time, personnel and improving customer satisfaction. All service providers gain a unique business generation tool that can quickly pay for itself many times over.

In accordance with the invention, it is envisioned that service providers will be provided with a subscription that allows the service provider to (a) learn the same information as the consumer regarding the steps and actions that comprise a service, (b) access the consumer's account and be able to check the boxes when they have completed required actions, (c) have the system tell the consumer when the actions are completed by the service provider, (d) be given points for each action that result in a step grade and ongoing grade, and (e) earn a final grade for performance that is shared with the consumer.

For additional modest monthly upgrade fees ($10-$20 per month/per service) the system may (1) send the consumer on behalf of the service providers a weekly summary update letter of all actions taken by the service provider to perform the service as well as (2) a monthly update letter which will have some customization for the service provider, and (3) list the service provider's grade together with their name, contact information, link to website and final grade in the inventive system's searchable database, allowing other consumers to easily find that service provider.

Additionally, for owners who are early adapters and require all their agents to become subscribers, the system has a valuable set of benefits. For instance, hitherto, it has been almost unimaginable for broker/owners to oversee the daily actions of hundreds or thousands of independent agents. Now, in return for broker/owners requiring all their agents to subscribe, the system can inform them every day which agents are performing at an A grade, which at a B grade and which at a C or a D grade. The system thus automates not only the accountability of agents, but additionally the daily training and management of real estate agents and other service providers. It allows broker/owners to engage fewer managers and provides a complete daily education program for hired agents that is highly specific and consumer-oriented while always being compliant with industry best practices, state and local laws and consumer preferences. Further, because the the system actions agents perform daily are industry and legally compliant, the liability of broker/owners is greatly reduced while the satisfaction of consumers with the agency is enhanced. Finally, hitherto broker/owners have had to engage in expensive and time consuming training courses for hired agents. Now, all agents and especially newer ones can learn their daily best practices at minimal cost to broker/owners and the system serves to weed out costly dead wood in a sales organization.

The inventive system may also become an essential tool for institutional clients such as Fannie Mae and Freddie Mac who together control over 1,000,000 properties. For an agent to deal with one of their listings, both institutions have certain actions required by all agents hired by them. The inventive system will be able to take these actions and add to them to its Action list under each Step and may even improve on them and, thus, provide unparalleled accountability for Fannie Mae and Freddie Mac.

The inventive system facilitates efficient and quality delivery of services by providers and comprises a server having a processing unit, and a computer-readable medium that stores: 1) a task database that lists a plurality of tasks associated with performance of a job; 2) a time goal database that lists goal completion time data for at least a first portion of the tasks; 3) a job database that lists a plurality of jobs; 4) an actual task time database that lists, for each job, actual time taken to perform each of the tasks in the first portion of the tasks; 5) a task weight database that lists a numerical value indicative of the importance to be accorded to each of the tasks in said the portion of the tasks; 6) an interim task grade database that lists, for each job, grades associated with at least a subset portion of the tasks in the first portion of the tasks; 7) a grading algorithm responsive to information in the time goal database, the actual task time database and the task weight database, the grading algorithm generates interim grades and stores the interim grades in the interim task grade database, the interim grades being based on listings in the task time goal database and the actual task time database; 8) an assigned provider database that lists a provider for each job; and 9) a prompting algorithm that is responsive to the time goal database and the task database to generate prompts which contain information respecting tasks to be performed in connection with a particular job. The inventive system also has a plurality of provider personal computing devices, each of the provider personal computing devices are associated with a provider associated in the assigned provider database with a job in the job database. The prompting algorithm causes the transmission of prompts to the provider personal computing device associated with the task to be performed in connection with a particular job, and the provider personal computing devices are adapted to send task time completion data to the actual task time database. The inventive system also has a plurality of client personal computing devices, each of the client personal computing devices are associated with a job for a particular client, the server computer hosts software that causes the transmission of interim task grade database information for a particular job to the client personal computing device associated with the particular job.

The grading algorithm of the inventive system, upon job completion, may respond to the task weight database and the interim task grade database and generates a system overall cumulative grade and stores the same in a system overall cumulative grade database.

The personal computing devices of the inventive system may be handheld devices.

The information in the interim task grade database that relates to a particular job may be sent to the personal computing device associated with the provider assigned to that particular job.

The computer-readable medium of the inventive system may store a excuse database that lists excuses for delays in task time completion, and the grading algorithm responds to said excuse database to increase a grade where an excuse is listed.

The computer-readable medium of the inventive system may store a client interim task grade and the client interim task grade for a particular job is communicated by the computer server to the personal computing device of the provider associated with the particular job.

The computer-readable medium of the inventive system may respond to a client personal computing device by receiving and storing a subjective client overall grade in a client overall grade database.

The inventive system further comprises a supervisory provider personal computing device to which the server is programmed to communicate information on the interim task grade database, and information on the client interim task grade database to the supervisory provider personal computing device.

The server on the inventive system computer may be programmed to communicate the prompts to the supervisory provider personal computing device.

The task database, time goal database, and the system overall cumulative grade database of the inventive system may be made available on the Internet.

The client overall grade database of the inventive system may be made available on the Internet.

In yet another embodiment, the present invention for regulating the quality of service providers, rating agents and managers, may have a server which has a processing unit, and a computer-readable medium which stores: 1) a task database that lists a plurality of tasks associated with performance of a job, 2) a time goal database that lists goal completion time data for at least a first portion of the tasks, 3) a job database that lists a plurality of jobs, 4) an actual task time database that lists, for each job, actual time taken to perform each of the tasks in the first portion of the tasks, 5) a grading algorithm that responds to information in the time goal database and the actual task time database and generates interim grades and stores the interim grades in an interim task grade database, 6) an assigned provider database that lists a provider for each job; and 7) a prompting algorithm that responds to the time goal database, the task database and the task time database and generates prompts that contain information respecting tasks to be performed in connection with a particular job. The inventive system also comprises a plurality of provider personal computing devices, and each of the provider personal computing devices are associated with a provider associated in the assigned provider database with a job in the job database, and the prompting algorithm causes the transmission of prompts to the provider personal computing device associated with the task to be performed in connection with a particular job, and the provider personal computing devices are adapted to send task time completion data to the actual task time database. Also, the inventive system has a plurality of client personal computing devices, and each of the client personal computing devices are associated with a job for a particular client, the server computer hosting software causes the transmission of interim task grade database information for a particular job to the client personal computing device associated with that particular job.

The computer-readable medium of the inventive system may store an excuse database that lists excuses for delays in task time completion, and the grading algorithm may be responsive to the excuse database to increase a grade where an excuse is listed.

The computable-readable medium of the inventive system may store a client interim task grade and the client interim task grade for a particular job may be communicated by the computer server to the personal computing device of the provider associated with the particular job.

The computer-readable medium of the inventive system may respond to a client personal computing device to receive and store a subjective client overall grade in a client overall grade database.

The inventive system may further have a supervisory provider personal computing device and wherein the server is programmable to communicate information on the interim task grade database, and information from the client interim task grade database to the supervisory provider personal computing device.

The server computer may be programmable to communicate the prompts to the supervisory provider personal computing device.

The task database, time goal database, and system overall cumulative grade database may be made available on the Internet.

The client overall grade database may be made available on the Internet.

In another embodiment the inventive system comprises a method in which a non-transitory computer-readable medium with instructions stored thereon, that when executed by a processor, automates the accountability of service professionals. The inventive method inputs steps for completing a professional service onto a server, connects to the server via a wireless communications network; presents the steps to a user; monitors the completion of the steps; stores the completion of the steps on a server; and calculates a grade based on the completion of the steps.

The professional service of the inventive method may be the buying, selling, leasing of real estate.

The steps of the inventive method may be formulated using industry standards.

The wireless communications network of the inventive method may be the Internet.

The inventive method may monitor the completion of the steps by presenting yes or no questions to a user device and allowing the user to enter information regarding the steps and optionally allowing the user to void the steps.

The inventive method may also send step completion notifications to a consumer.

The consumer using the inventive method may provide grading input.

In another embodiment of the invention, a non-transitory computer-readable medium with instructions stored thereon, that when executed by a processor, automates the accountability of service. The inventive method inputs steps for completing a professional service onto a server; connects to the server via a wireless communications network; presents the steps to a user and consumer; monitors the completion of the steps; stores the completion of the steps on a server; compares the input of the user and he consumer; and calculates a grade based on the completion of the steps.

The inventive method may compare the user and the consumer inputs resulting in an option that allows for the user and consumer to re-enter the input again if the user and consumer inputs do not match.

The inventive method may result in two different grades if the comparison of the user and the consumer inputs do not match.

The inventive method may compare of the user and the consumer inputs resulting in one final grade combined with an explanation provided by the user or the consumer.

Yet another embodiment of the inventive for automating the accountability of service professionals may comprises a server that stores steps for completing a professional service; a wireless communications network connected to the server; a computer device that presents the steps to a user; and software that monitors the completion of the steps, stores the completion of the steps, and calculates a grade based on the completion of the steps.

The professional service of the inventive system may be the buying, selling, and/or leasing of real estate.

The steps of the inventive system may be formulated using industry standards.

The steps of the inventive system may be part of a menu or submenu items.

The wireless communications network of the inventive system may be the Internet.

The inventive system may monitor the completion of he steps by presenting yes or no questions to a user and allowing the user to enter information regarding the steps and optionally allowing the user to void the steps.

The inventive system may further send step completion notification(s) to a consumer.

A consumer may also provide grading input in the inventive system.

The inventive system may not take some of the steps into account for grading.

### BRIEF DESCRIPTION THE DRAWINGS

The operation of the invention will become apparent from the following description taken in conjunction with the drawings, in which:

FIG. 1 is a general overview of the inventive system;

FIG. 2 is a flowchart illustrating the method of creating an account on the inventive system;

FIG. 3 is a flowchart illustrating the method of selecting a service professional using the inventive system;

FIG. 4 is a flowchart of another embodiment illustrating the method of selecting a service professional using the inventive system

FIG. 5 is a flowchart of the inventive system in which the system educates a user and service professional and grades the service professional;

FIG. 6 is a flowchart of the grading system used by the inventive system;

FIG. 7 is another embodiment of the inventive system illustrating the grading of a service professional;

FIG. 8 illustrates an embodiment of the graphical user interface for the home screen of the inventive system;

FIG. 9 illustrates an embodiment of the graphical user interface for creating an account on the inventive system;

FIG. 10 illustrates an embodiment of the graphical user interface for creating an account on the inventive system;

FIG. 11 illustrates an embodiment of the graphical user interface for terms and agreements screen for the inventive system;

FIG. 12 illustrates an embodiment of the graphical user interface for a confirmation screen on the inventive system;

FIG. 13 illustrates an embodiment of the graphical user interface for an about screen on the inventive system;

FIG. 14 illustrates an embodiment of the graphical user interface for service list on the inventive system;

FIG. 15 illustrates an embodiment of the graphical user interface for service list on the inventive system;

FIG. 16 illustrates an embodiment of the graphical user interface for service description screen on the inventive system;

FIG. 17 illustrates an embodiment of the graphical user interface for a service professional list and search screen on the inventive system;

FIG. 18 illustrates an embodiment of the graphical user interface for a service professional invite screen on the inventive system;

FIG. 19 illustrates an embodiment of the graphical user interface for a service professional interview question screen on the inventive system;

FIG. 20 illustrates an embodiment of the graphical user interface for a service professional interview question screen on the inventive system;

FIG. 21 illustrates an embodiment of the graphical user interface for a service professional selection screen on the inventive system;

FIG. 22 illustrates an embodiment of the graphical user interface for a confirmation of service professional selection screen on the inventive system;

FIG. 23 illustrates an embodiment of the graphical user interface for a service professional biography screen on the inventive system;

FIG. 24 illustrates an embodiment of the graphical user interface for a service menu screen on the inventive system;

FIG. 25 illustrates an embodiment of the graphical user interface for a service step question screen on the inventive system;

FIG. 26 illustrates an embodiment of the graphical user interface for a service step question screen on the inventive system;

FIG. 27 illustrates an embodiment of the graphical user interface for an explanation of a service question screen on the inventive system;

FIG. 28 illustrates an embodiment of the graphical user interface for an override screen on the inventive system;

FIG. 29 illustrates an embodiment of the graphical user interface for an explanation of grading system screen on the inventive system;

FIG. 30 illustrates an embodiment of the graphical user interface for a grade detail screen on the inventive system;

FIG. 31 illustrates an embodiment of the graphical user interface for a transaction detail screen on the inventive system; and

FIG. 32 illustrates an embodiment of the graphical user interface for a transaction progress screen on the inventive system;

FIG. 33 is a flowchart of one embodiment of the grading system used by the inventive system;

FIG. 34 is an overall flowchart of one embodiment of the inventive system.

### DETAILED DESCRIPTION OF THE PREFERRED EMBODIMENTS

The present invention provides a consumer with a system comprising a user-friendly interface, which enables a consumer to easily understand often complex, unfamiliar and unknown steps of a particular service transaction. For example, the present invention breaks down the process of selling a home into easily digestible steps, which educates the consumer about how the process works and what their real estate agent should be doing. This knowledge then empowers the consumer to attain better service from a service professional as the consumer can now follow a service professional's moves and suggest adherence to the steps detailed in the inventive system, and demand an understanding of the process being executed on his behalf by following the step by step guidance presented by the system of the present invention.

Thus, the present invention automates the accountability of service professionals as the consumer will be following their progress in a knowledgeable way and will question the service professional when a step is missed.

The present invention also acts as a guide and grading system for service professionals. A service professional using the present invention will also be presented with easily digestible steps to accomplish a particular service being rendered. Then, based on the service professional's actions, the system of the present invention generates a series of grades. These grades allow a consumer to know how a service professional has performed in the past and how that service professional is currently performing, as well as giving the consumer an overall trend of how that service professional has performed over a period of several transactions.

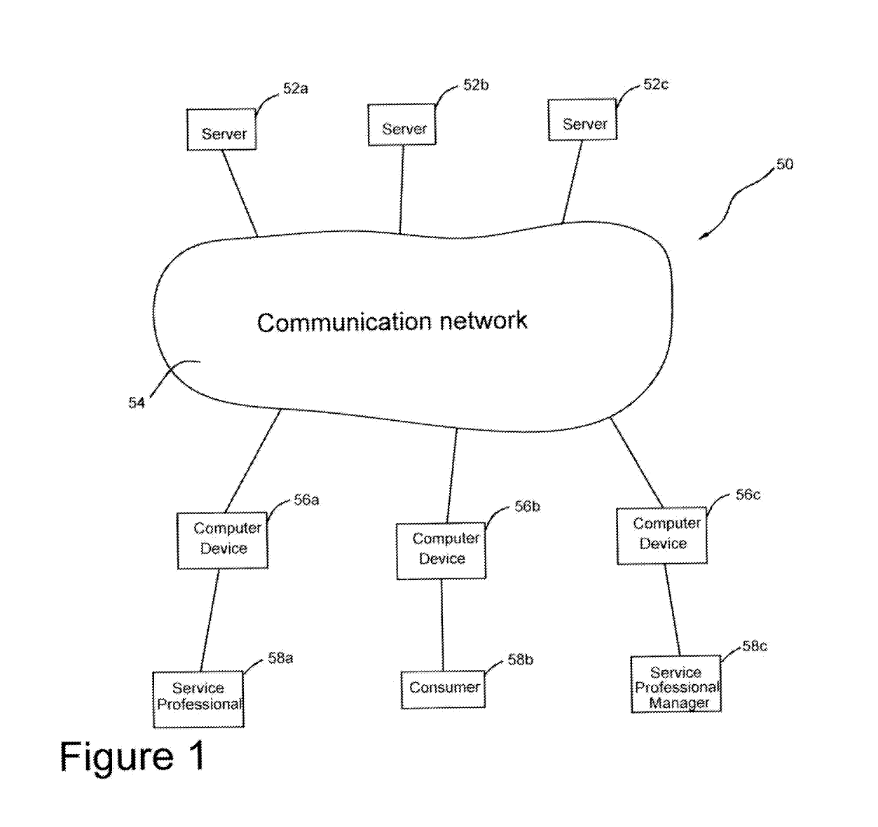

Referring to FIG. 1, an overview of inventive system 50 may be understood. Inventive system 50 comprises a server 52a or multiple servers 52a-c, for example, which may or may not be connected with each other. The server or servers are connected to communications network 54, which is connected to computer devices 56a or multiple computer devices 56a-c. Communications network 54 may be the Internet, which may be accessed in a variety ways such as through telephone lines, broadband connections like cable and DSL, satellite connections, and various wireless connections, etc. Computer devices 56a-c may be a personal computer, laptop, tablet, smartphone, or any other device capable of being connected to the Internet. User 58a or users 58a-c, are then able to use computer devices 56a-c to connect to communications network 54 and in turn connect to servers 52a-c of the present invention. Users 58a-c of system 50 may include, but are not limited to, service professionals (such as real estate agents, consumers, and service professional managers.

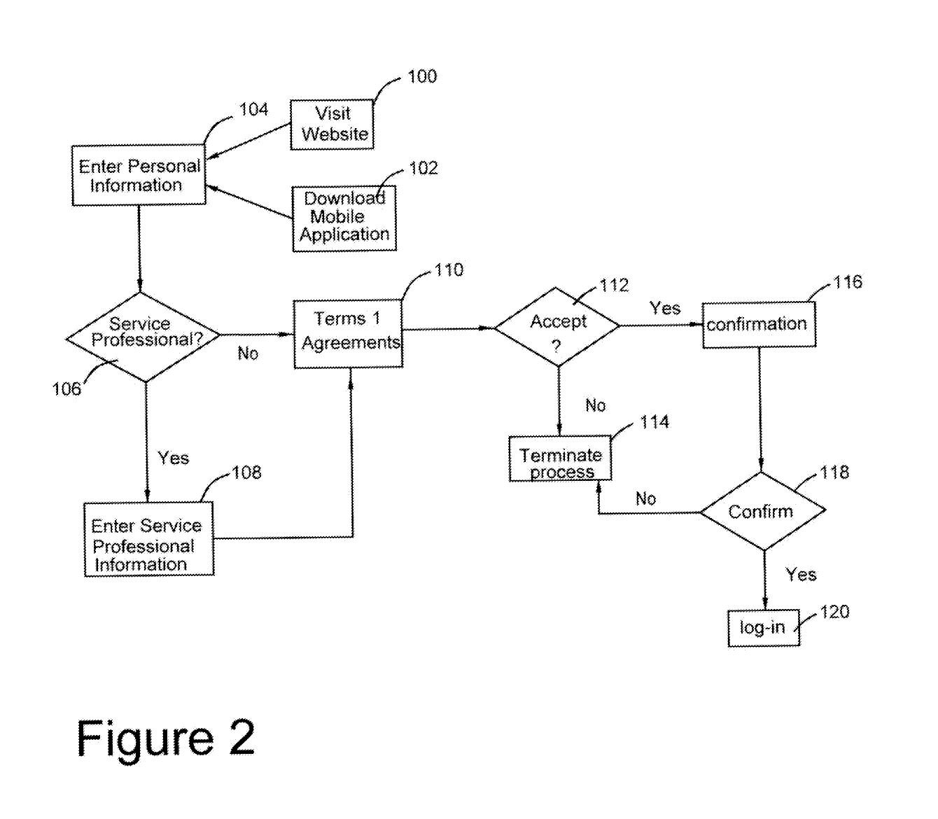

Once a user has connected to inventive system 50 through communications network 54, user 54 creates an account with inventive system 50 as illustrated in FIG. 2. User 58 can utilize system 50, for example, through one of two ways, visiting a website as in step 100 or downloading a mobile application as in step 102. Once user 58 has entered system 50 through either step 100 or 102, the user proceeds to step 104 to create an account by entering their personal information. Personal information may include a user's name, address, and e-mail address, but may include less information or more comprehensive information.

Once a user has entered their personal information, they will indicate whether or not they are a service professional at step 106. If the user indicates that he or she is a service professional, the system will proceed to step 108, where the user will enter their service professional information. Service professional information may include the service professional's firm and/or organizational names, the service professional's phone number, the service professional's licensing information, and the service professional's photo, etc. Once the user's service professional information is entered or the user has indicated they are not a service professional, the system will proceed to step 110. At step 110, system 50 will present the user the terms and agreements for use of system 50. The terms and agreements may consist of legal disclaimers, end-user licenses, etc. Once the user has read the terms and agreements, the system will prompt the user to indicate if the user agrees to the terms and agreements at step 112. If the user indicates he/she does not agree to the terms and agreements, the system will terminate the process at step 114. Alternatively, if the user indicates he/she agrees with the terms and agreements, the system will proceed to step 116. At step 116, system 50 will send a confirmation to the user. The confirmation may be a confirmation e-mail, sms message, a verification webpage, pop-up notice, or any such other means of providing notice or confirmation to a user. The user then proceeds to step 118, where he/she indicates if they confirm the creation of his/her account. If the user does confirm his/her account, the system proceeds to step 120 and presents the user with a login page. If the user does not confirm his/her account the system will proceed to step 114 and terminate the process. The period in which a user may confirm his/her account may be completely open ended, or system 50 may impose a time limit such as one day, one week, one month, or any appropriate time period.

Once user 58 has followed steps 100-118 to create an account and logged in at step 120, user 58 indicates the service they require. In a preferred embodiment, system 50 is used by consumers to find a real estate agent. However, system 50 may be used by consumers to find any type of service professional.

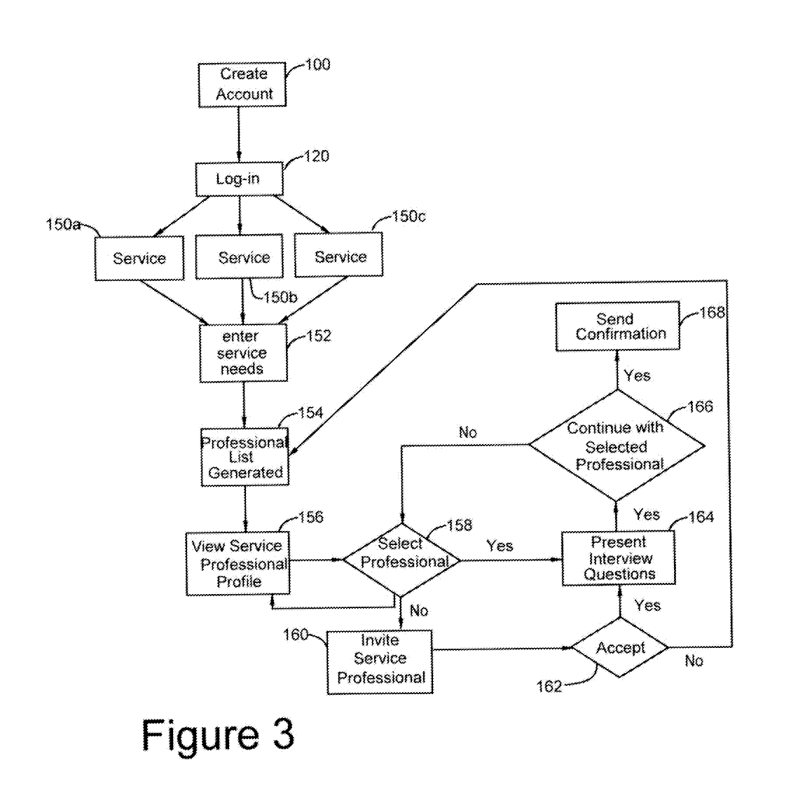

Referring to FIG. 3, in the present embodiment, user 58 indicates at step 150 the service he/she requires from the real estate agent. For example, user 58 may want a real estate agent to lease a property 150a, sell a property 150b or buy a property 150c. Step 150 would be tailored for the specific type of service professional being sought by user 58. For example, user 58 may be searching for an attorney and at step 150, user 58 would choose the type of attorney he/she would like to retain the service of, e.g., intellectual property, divorce, family, immigration, etc.

Once user 58 has chosen the type of service professional he/she requires, user 58 inserts his/her service needs at step 152. In a preferred embodiment of the present invention, the service being sought would be the service of a real estate agent and the user's service needs would be a description of the property being sold or sought. The property information input at step 152 may include as little as the address of the property and the type of property. Additionally, the property information collected at step 152 may be more comprehensive, including a desired asking price for the sale of the property, the desired price range for buying or leasing a property, the date service is desired to begin/end, etc. Step 152 would be tailored for the specific type of service being sought by user 58. For example, user 58 may enter why he/she is seeking the service of an intellectual property lawyer, how much user 58 desires to spend on an attorney, etc.

Optionally, the user may be invited to submit a free form description of the service needed. Alternatively, the system could present a menu for the entry of information. Such menu may be constructed to evolve in response to the answer given by the consumer. The first question might be answered by the stated need for an attorney. The next question might choices like family, immigration, intellectual property, etc. If intellectual property were selected, the system may produce the choices of “patent,” “trademark,” “copyright,” or “other.”

After the service needs of user 58 are collected at step 152 a list of service professionals is generated at step 154 based on the geographical location of user 58. The service professional list generated at step 154 may include service professionals registered and graded, as discussed below, by system 50. Alternatively, the service professional list may also include service professionals not registered with system 50. A distinction may be made between service professionals registered with the inventive system 50 and those not registered with inventive system 50. For example, service professionals registered with inventive system 50 may be listed in a different color, highlighted, indicated by a letter or symbol, or any other type of distinguishing marker.

In an alternative embodiment of the present invention, the system will enable user 58 to narrow the search results for a particular type of service professional based on the service professional's grades generated by system 50 as disclosed in detail below.

User 58 reviews the generated service professional list at step 156 and then decides whether he/she wishes to proceed with a listed service professional. If user 58 selects a listed service professional at step 158, system 50 will present to user 58 a series of recommended interview questions at step 164.

In accordance with the invention, such interview questions may be sent over the internet by email facilitated and provided by the operator of the inventive system. However, the invention may be practiced, alternatively, by providing the service professional's telephone number to the prospective client and allowing the interview to go forward over the telephone.

Once user 58 has interviewed the service professional, the system will prompt user 58 to indicate to the system whether the user would like to proceed with the selected service professional at step 166. If user 58 indicates he/she will proceed with the selected service professional, system 50 will generate a confirmation of the service professional selection at step 168.

At step 158, user 58 may alternatively indicate that they wish to invite a service professional known to user 58 that is not listed. At step 160, system 50 sends an invite to the service professional. This invite may be in the form of an electronic notification such as email or SMS. Alternatively, system 50 may generate a telephonic voice notification to the service professional. If the invited service professional declines the invitation, system 50 will return to step 154 and present user 58 with the service professional list previously generated. If the invited service professional accepts the invitation, system 50 will proceed to steps 164-168 as described above.

In accordance with the invention it is recognized that some steps in the process may take more than a few minutes, and perhaps a few days. At certain steps in the process, for example the invitation of a service professional or the interview of a service professional, the user is offered the opportunity to sign out of the process. This sign out option can, in accordance with one preferred embodiment of the invention be offered at any time to give users flexibility and make using the system more convenient. Once a user has been signed out, the user may reenter the process by logging on to her or his account and resuming the execution of the method of the present invention, as detailed herein.

Alternatively, it is also contemplated in accordance with the invention that the system may put the user in contact with several professionals, allowing the user to gauge the different answers of different professionals with respect to each other. A further alternative is for the interview phase to go forward by email with all potential service providers copied in on all email communications giving the competing service providers the opportunity to amplify the conversation and promote the user's understanding of the process. At the same time, service providers may learn from each other.

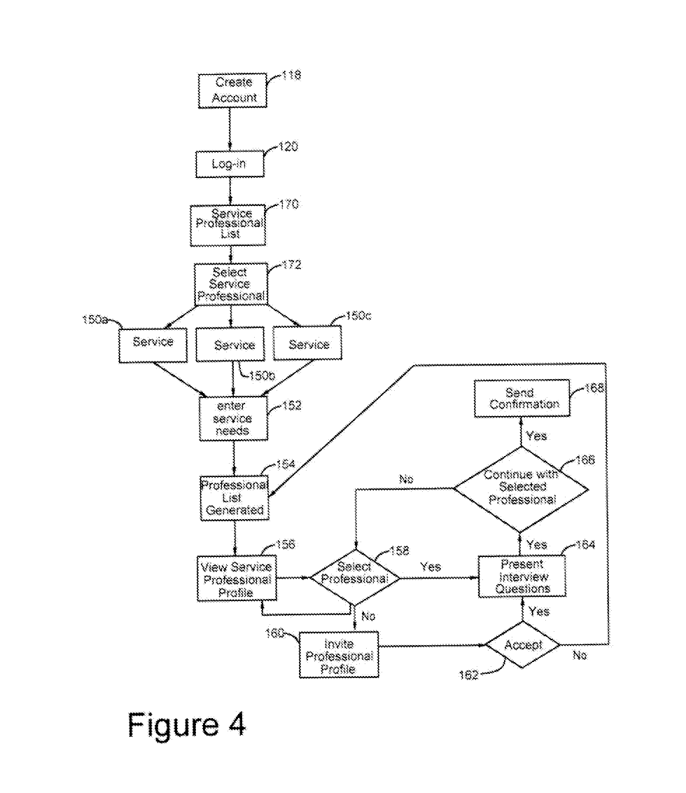

In another embodiment of the present invention, system 50 provides user 58 with the ability to search for service professionals from many different fields, for example when the user has a particular type of service professional in mind and would like to use the inventive system in connection with a possible engagement. The operation of the invention in accordance with such an alternative embodiment is illustrated in FIG. 4.

FIG. 4 is substantially identical to FIG. 3, but with additional steps 170 and 172 after login step 120 and before service selection step 150. In accordance with this alternative, when a user logs into system 50 at step 120, system 50 presents user 58 with a list of different service professionals. User 58 then identifies the type of service professional the user is looking for at step 172 and the system then proceeds through steps 150-168 as described above.

In yet another embodiment, inventive system 50 provides user 58 with a search box at step 170. User 58 types in the type of service desired and system 50 generates a results list. User 58 then selects the type of service professional at step 172 and proceeds through steps 150-168 as detailed above.

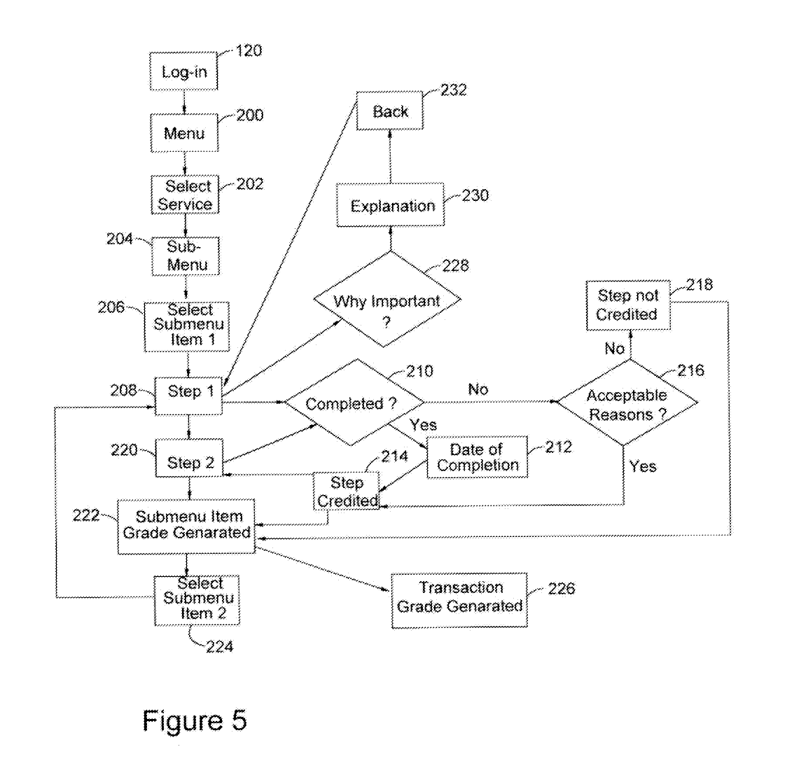

In addition to providing consumers with a service professional search tool as described above, structure of the inventive system 50 and the above features and functions also complement service as an educational tool for the consumer as well as service professionals. More particularly, referring to FIG. 5, once user 58 logs into system 50 at step 120, and selects the type of service at step 150 and selects a service professional as in steps 152-172, system 50 will then present user 58 with a menu screen at step 200. Referring to FIG. 5, menu screen at step 200 contains a list of on-going services based on what user 58 has indicated at step 150-152. Thus, if user 58 has indicated that he wants to sell a property at steps 150-152, menu screen at step 200 will list “sell a property”. If user 58 is using system 50 for multiple services such as selling a property and patent prosecution, system 50 will list “sell a property” and “patent prosecution” on the menu screen at step 200. The menu at step 200 will list the services in connection with which user 58 is using system 50.

User 58 selects the on-going service he/she wants to view at step 202. System 50 then presents user 58 with a submenu at 204 based on what the particular service user 58 selects at step 202. For example, if user 58 selects “sell a property” at step 202, submenu 204 will contain a list of steps a service professional would likely need to complete to accomplish the selected service. The submenu steps listed at step 204 may be based on the industry best practices for the particular service selected. For example, if user 58 selects “sell a property”, system 50 would list at step 204 a submenu with submenu steps based on the best practices of the real estate industry. In the example of selling a property, system 50 may list at step 204: 1) listing agreement; 2) preparation; 3) marketing (broker); 4) marketing (consumer); 5) showings; 6) offers; 7) negotiations; 8) contracts; 9) closing; and 10) after the sale. In the example of patent prosecution, system 50 might list at step 204: 1) retainer agreement; 2) client disclosures; 3) patent drafting; 4) patent filing; 5) patent prosecution after filing; 6) patent issuance; and 7) post-issuance.

When consumers open an account, they find adjacent to each action under each step in the service process a “Why?” hyperlink that will take consumers to an almost encyclopedic explanation of why the system recommends this action to be taken. The system will support its recommended actions with both a layman's explanation and specific citations from sources including the code of ethics belonging to that profession, federal, state and local consumer protection laws, consumer advocate recommendations, and legal requirements imposed by state licensing commissions. Thus, the system provides the steps and the specific actions that make up a quality service as well as the “Why?” rationale for their being performed, creating an informed and empowered consumer.

User 58 can select any submenu step at step 206 and system 50 will present user 58 with a series of actions presented as detailed yes/no questions at step 208 in order to ascertain if a service professional has completed the particular submenu step according to industry standards and best practices. User 58 will indicate either yes or “no” as to whether the service professional has completed the action asked about in step 208 at step 210. If user indicates yes, system 50 will either auto fill the date or prompt user 58 to enter the date the action was completed at step 212. After user 58 enters the date the action was completed at step 212 or system 50 automatically fills in the date at step 212, system 50 will credit the service professional with completing the action at step 214. If user 58 indicates “no” at step 210, system 50 will present user 58 with a screen asking user 58 if there is a reason the service professional has not completed the particular action at step 216. If user 58 indicates there is a reason the action was not completed, system 50 will proceed to step 214. If user 58 indicates there is no reason why the service professional has not completed the particular action, system 50 will not credit the service professional and mark the action incomplete at step 218.

In an alternative embodiment of the invention a control board may determine a time frame the actions detailed in the yes/no questions should be completed by. For example, certain action should be completed within 24 hours of the beginning of the service, while others may have time frames of 48 hours, one week, one month, etc. The control board may be made up of industry leaders and experts.

After system 50 has reached either step 214 giving credit to the service professional or step 218, marking the action incomplete, system 50 will then proceed in one of two ways. First, system 50 may proceed to step 220, which is another action presented as a detailed yes/no question related to submenu item 1. System 50 will then proceed through steps 210-218 as described above. This process may repeat as many times as is necessary to determine if a submenu item step has been adequately completed. For instance, a particular submenu item step may only require one or two actions, while some may require ten or more. The number of actions under a particular submenu item step will be determined by the nature of the service being provided, the industry standards and best practices, and consumer and industry feedback.

Alternatively, system 50 may proceed to step 222 after system 50 has reached either step 214 giving credit to the service professional or step 218, marking the action incomplete. At step 222, system 50 generates a grade for the selected submenu item step based on steps 208-220. Referring back to the example of selling a property, if the submenu item step selected by user 58 is “listing agreement”, system 50 will present user 58 with one or more actions presented as detailed yes/no questions related to “listing agreement”. Based on the number of yes/no answers, system 50 will generate a grade. For instance, if user 58 selects “yes” to two questions and “no” to one question, system 50 will generate a grade based on the service professional completing two out of three recommended steps for submenu item “listing agreement”. In a preferred embodiment of the present invention, each submenu item will be worth 100 points. Every action, presented as detailed yes/no questions, will be worth a certain point value to be determined by a control board. In this embodiment, a submenu item may have two actions, with one action being worth 70 points and the second action being worth 30 points, or a submenu item may have five actions, each worth 20 points, etc. Once a submenu item step is completed, a letter grade will be generated for that submenu item step based on the total number of points credited for each underlying action (0-100). For example, 90-100 points may be an “A”, 80-89 points a “B”, 70-79 points a “C”, 60-69 points a “D”, and 0-59 points an “F”.

In an alternative embodiment, system 50 will assign or take away a certain number of points per action question. For example, if user 58 answers “yes” at step 210, system 50 will give the service professional points at step 214. However, if user 58 answers “no” at step 210 and gives “no” acceptable reason at step 216, system 50 will deduct points or credit zero points at step 214. Then at step 222, system 50 will total all the points assigned and deducted to arrive at the submenu item grade. The submenu item grade may be a letter grade based on the number of points achieved. For example, 400 to 500 points would be an A grade, 300 to 400 would be a B, 200-300 would be a C, 100-200 would be a D and less than 100 would constitute an F grade.

In yet another embodiment of the present system, the system may generate A+, A−, B+, B−, C+, C− grades based on subjective comments from user 58, or different point structures.

In yet another embodiment of the invention, a control board may assign a certain number of points to each step of the submenu totaling 100 points for each submenu item step. For example, if there are 10 steps under a submenu, step 1 might be weighted 5 points, step two 10 points, step three 15 points, etc. The control board may be made up of industry leaders and experts.

In accordance with a particularly preferred embodiment of the invention, the service provider, too, can always log into the inventive system and see the grade level at which the service provider is operating and immediately correct any omissions or deficiencies and improve the service provider's grade. In this way, the service provider can always be operating at an “A” level grade.

Grades may appear on the initial screen of the application whenever the consumer logs into their account 24/7, 365 days a year. In this way, consumers can always instantly see at what grade level their service provider is operating. So, too, service providers can always log in and see at what grade level they or their employees or independent sales associates are operating. It is expected that most service providers and/or their supervisors, will log in every morning to make sure they are operating at optimal grading levels.

Once system 50 has generated a grade for the first submenu item at step 222, system 50 will proceed in one of two ways. First, system 50 will proceed to the second submenu item at step 224 and repeat steps 208-222 as described above. Once system 50 has run through all submenu items for a particular submenu, system 50 will generate an overall grade for the submenu at step 226. In a preferred embodiment, system 50 will weight each step, each worth 100 points, according to the recommendations of a control board taking into account consumer feedback, and the importance of each step based on industry standards and best practices at step 226. For example, in the real estate steps outlined above “listing agreement” may be weighted 10% of the overall grade, while “negotiations” may be weighted 25% of the overall grade.

In an alternative embodiment, if the submenu item presented at step 204 had 10 submenu items, system 50 would average the 10 grades generated at step 222 resulting in an overall grade at step 226 for the submenu.

Alternatively, there may only be submenu item for a particular submenu, and system 50 will proceed directly to step 226 in which the grade for the submenu would be the same grade generated at step 222.

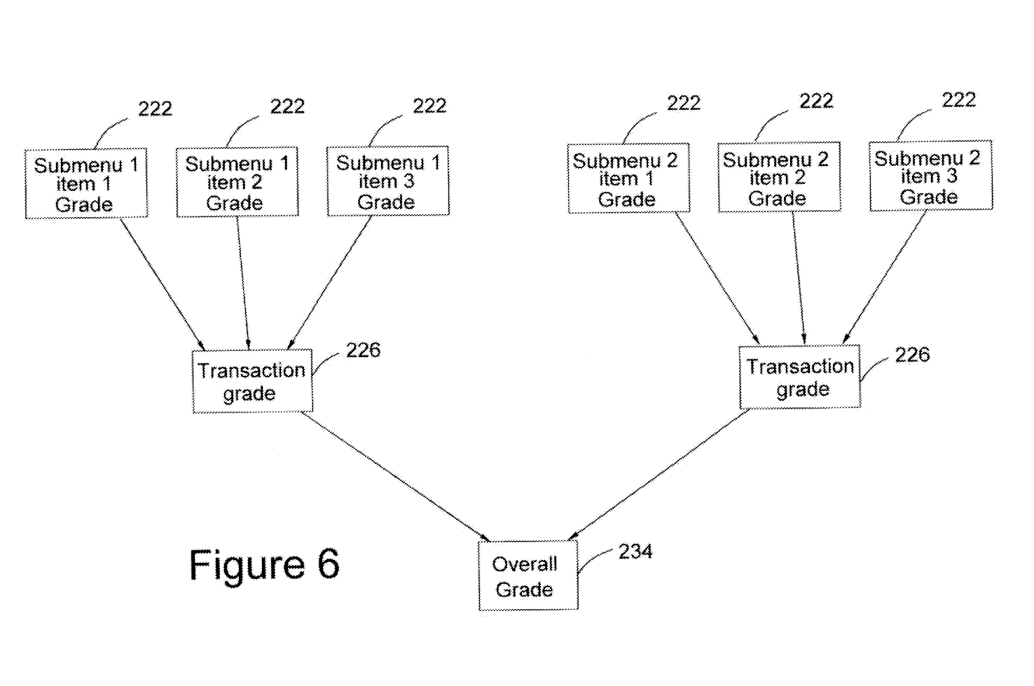

As is apparent from the description above, there may be one or more submenu item grades generated at step 222 which result in an overall transaction grade at step 226. Once system 50 has completed steps 208-226 for all submenu items, system 50 will then generate an overall grade at step 234 as illustrated in FIG. 6.

In an alternative embodiment of the present inventions, each submenu item grade generated at step 222 may be weighted a certain percentage of the transaction grade generated at step 226. For example, submenu item grade 1 may be weighted 10% of the transaction grade, submenu item grade 2 may be weighted 25% of the transaction grade, etc. The weighting may be determined by a control board. The control board may be made up of industry leaders and experts.

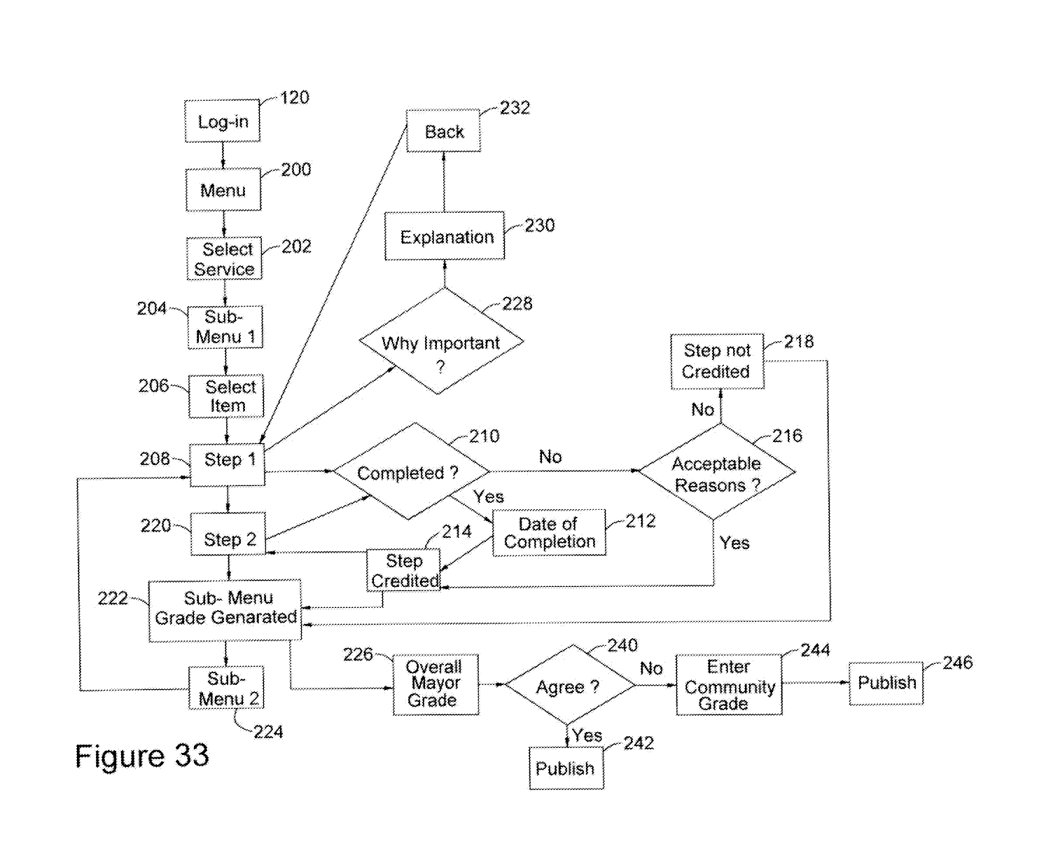

In an alternative embodiment of the present invention, a user may submit his/her own subjective comments and grade if user 58 does not agree with a system generated grade. Referring to FIG. 33, once system 50 has generated a transaction grade at step 226, user 58 will indicate whether he/she agrees with the grade generated by system 50 at step 240. If user 58 indicates he/she agrees with the generated grade, system 50 will publish the generated grade to the service professional's biography page at step 242. If user 58 indicates he/she does not agree with the grade generated at step 240, system 50 will prompt user 58 to enter comments and a subjective grade at step 244. Once user 58 has entered his/her own comments and grade system 50 will then publish both the system generated grade and the user grade at step 246. As described above, system 50 may use the comments and grade given by user 58 to increase or lower the transaction grade.

In another embodiment of the present invention, system 50 may proceed to step 228 from step 208. At step 208, user 58 may select a prompt from system 50 at step 228 inquiring why the particular submenu item is important to the service being rendered. System 50 will then provide an explanation at step 230. Once user 58 has read the explanation, user 58 may then navigate back to step 208 by selecting a prompt or link at step 232.

System 50 thus teaches user 58, based on industry best practices and standards, the steps that should be followed by a service professional in order to complete a particular service. System also allows user 58 to contribute to a rating system of a service professional by indicating if the steps that should be followed by a service professional in order to complete a particular service have been completed. This process results in 3 sets of grades for a service professional. The first grade, which is visible on an agent's profile on system 50 is grade for each submenu item presented to user 58 at step 204. The second grade would be a transaction grade based on the average of all the submenu item grades. Lastly, a third grade would be an overall grade based on the average of all transactions the service professional has performed. The grading system of system 50 is illustrated in FIG. 6. Each submenu item is graded at step 222, with the average of the submenu item grades resulting in the transaction grade at step 226. Each transaction grade is then averaged, resulting in an overall grade at step 234.

The service professional will also be able to view the grades that system 50 generates as described above and in FIG. 5-6; thus enabling the service professional to see his/her strengths at each step in a given transaction.

In the same way system 50 educates consumer, user 58a, about the steps a service professional should be taking to complete a specific transaction, the service professional, user 58b, is also educated about the process. A service professional creates an account as described for FIG. 2 above. The system would follow substantially the same process as detailed in FIGS. 4-5 above as user 58. Referring to FIG. 5, the service professional would log into system 50 at step 120. System 50 would then present the service professional with a menu screen at step 200. The menu screen at step 200 will list all transactions the service professional currently has in progress as well as all closed or completed transactions. The overall grade for each transaction will be displayed adjacent to the transaction. If the transaction is completed, the grade will be the transaction grade as displayed in step 226. If the transaction is in progress, the grade displayed adjacent to the transaction will be the average grade of all submenu grades displayed at step 222 completed. For example, if a transaction consists of ten submenu steps and the service professional has only completed five steps, the grade displayed will be the average of all five grades for the five completed steps. System 50 will also display the last submenu step completed next to the average grade. Alternatively, system 50 may use any of the grading schemes detailed above. Further, system 50 may display the most recent transaction grades to demonstrate a trend line. For example, system 50 may display the past three transaction grades, enabling User 58 to see how a service professional has performed in the most recent past transactions compared to older transactions.

The service professional will then select the on-going service he/she wants to view at step 202. The service professional will then be able to use system 50 as a step-by-step guide on how to complete the transaction to his/her industry's best practices and standards. Once the service professional has selected the transaction he/she wants to view at step 202, system 50 will then present the service professional with a submenu at step 204. The submenu presented at step 204 will consist of various submenu items, next to which there will be grade displayed, which will be calculated as detailed above and in FIGS. 5-6.

The service professional may then select a particular submenu item at step 206 and system 50 will display the detailed questions system 50 presents to user 58 at step 208.

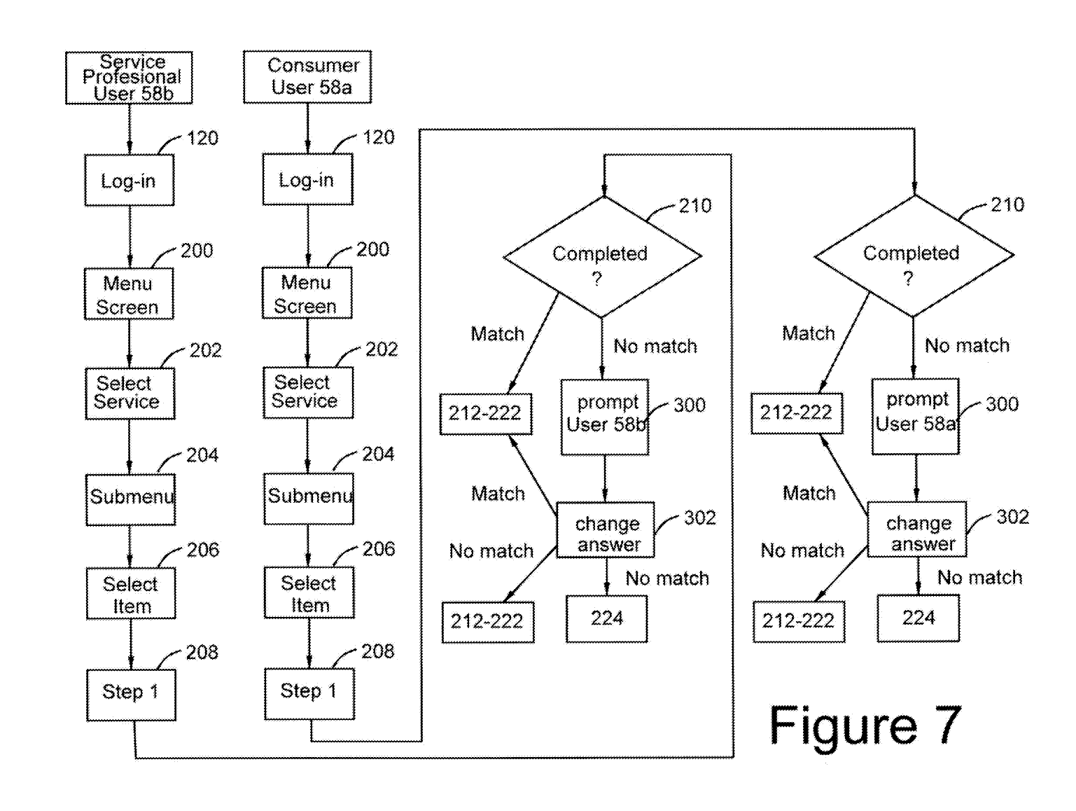

In a preferred embodiment, system 50 allows the service professional and the consumer to go through steps 210-226. In this embodiment system 50 would compare the answers input by user 58a and the service professional, user 58b, at steps 210-216. Referring to FIG. 7, if the answers match, the system will proceed through steps 212-22 as detailed in FIGS. 5-6. If the answers input by the consumer, user 58a and the service professional, user 58b, at steps 210-216 do not match the system will alert user 58 and the service professional of the incongruence at step 300. User 58 and the service professional will then either change their given answers or not at step 302. In the event, the answers given by user 58 and the service professional still do not match, system 50 will rely on the answers given by the consumer, user 58a, and proceed through steps 212-222.

In an alternative embodiment of the present invention, system 50 allows the service professional to go through steps 210-226 and locks the consumer out of steps 210-226. Thus, the consumer will be able to view when the service professional has completed certain steps and the service professional's progress, but will not be able to have an input him/herself.

In an alternative embodiment of the present invention, system 50 will lock the service professional out of steps 210-226. Thus, the service professional may only view the submenu items and the steps required to adequately complete the submenu items in conformity with the service professional's industry best practices and standards.

In an alternative embodiment, when the answers given by user 58 and the service professional at steps 201-2016 do not match even after the prompt is given at step 300 and opportunity to change is given at step 302, system 50 will rely on the answers given by the service professional, user 58b, and proceed through steps 212-222.

In yet another embodiment, when the answers given by the consumer, user 58a and the service professional, user 58b, at steps 201-2016 do not match even after the prompt is given at step 300 and the opportunity to change is given at step 302, system 50 will not enter or calculate a grade until matching answers are input into system 50 by the consumer user 58a, and the service professional, user 58b, and proceed to the next submenu item at step 224.

In any of the above embodiments, if at step 302, the answers given by user 58 and the service professional match, system 50 will proceed through steps 212-222.

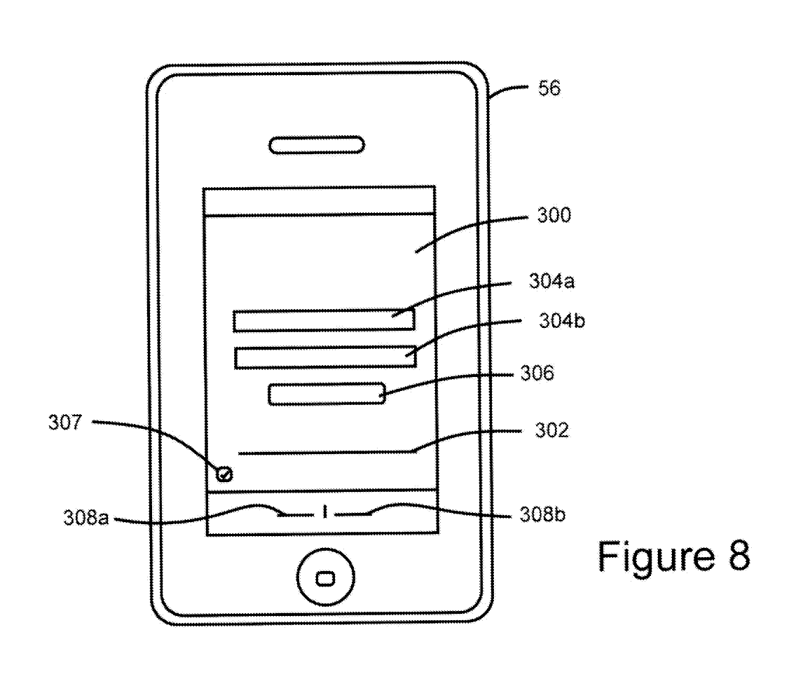

FIGS. 8-32 illustrate embodiments of the graphical user interface associated with system 50. FIGS. 8-13 generally relate to system 50 as illustrated and described above for FIG. 2. FIG. 8 illustrates an embodiment of mobile application home page 300 of system 50 on computer device 56. User 58 would access home screen 300 on computer device 56 through communication system 54. Once user 58 has accessed home screen 300, user 58 would use link 302 to create a new account as illustrated in FIG. 2. Alternatively, user 58 would input previously created login information in text fields 304a-b and click submit button 306. Once user 58 has created an account, user 58 will have the option to indicate on home screen 300, that user 58 wants system 50 to store his/her account information by clicking button 307; thus eliminating the need to type in the account information each time user 58 accesses home screen 300. Home screen 300 also contains links 308a-b to an about page and a terms page so that user 58 may familiarize him or herself with the system and the terms of using the system before creating an account or logging into the system.

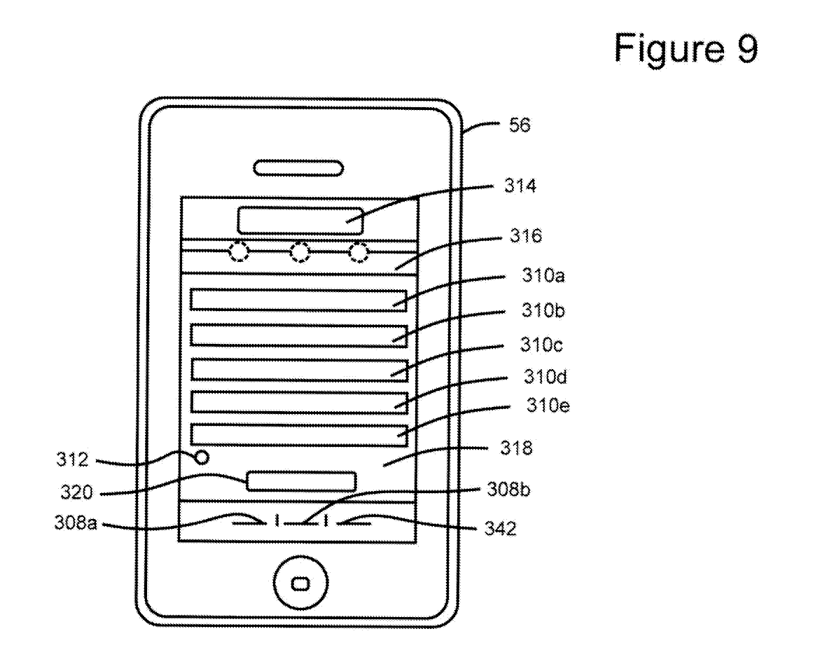

Once user 58 has clicked link 302 to create a new account, the user will follow the steps as illustrated in FIG. 2. FIG. 9 illustrates an embodiment of the graphical user interface for step 104 in which user 58 inputs his/her personal information on sign up screen 318. Screen 318 contains field 314 which indicates to user 58 the step in the process user 58 is currently on. Screen 318 also contains field 316, which indicates to user 58 the progress of user 58 through each step displayed in field 314. For example, while user 58 is creating an account, field 314 would display “Sign Up” and field 316 will display the three substeps of signing up, for example, “Sign Up”, “Terms”, and “Get Started”. Field 316 will follow the progression of user 58 and change each time user 58 completes a substep. For example, once user 58 is done inputting his/her information on screen 318 and proceeds to the next step, field 316 will change to highlight the next step. Field 316 may also indicate that the previous steps have been completed.

User 58 would input his/her personal information into text fields 310-e. User 58 would then proceed to step 106 and indicate whether he/she is a service professional by selecting link 312. If user 58 indicates he/she is a service professional, the system proceeds to step 108. If user 58 does not indicate he/she is a service professional, user 58 clicks link 320 and the system proceeds to step 110.

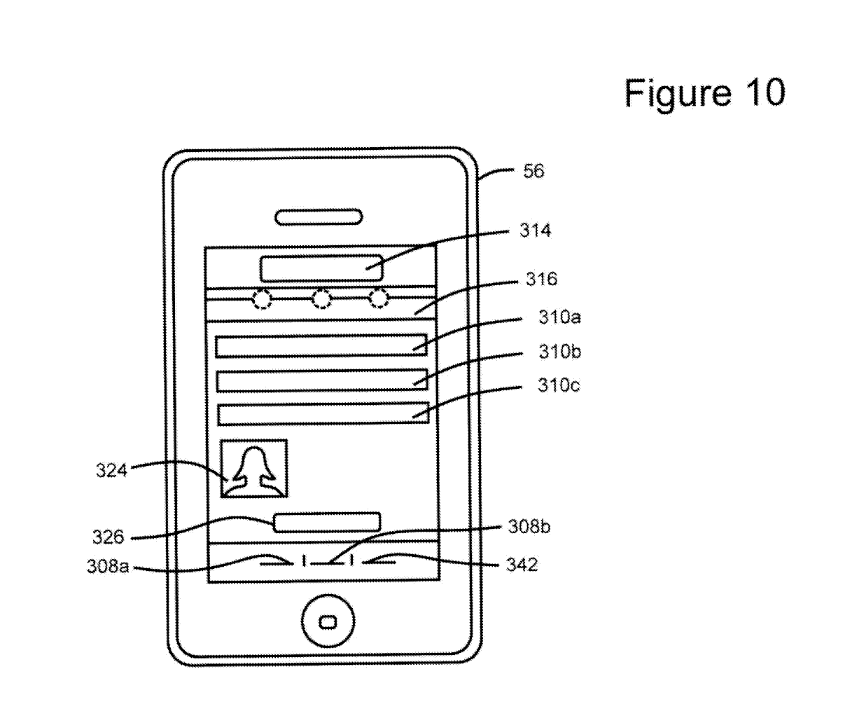

FIG. 10 illustrates an embodiment of the graphical user interface for step 108. User 58 would input his/her professional information in text fields 322-c. For example, a real estate agent may input a firm name, a phone number, and a state license number. User 58 may also upload a photo in space 324. Once user 58 has completed step 108, user 58 would click button 326 and the system would proceed to step 110.

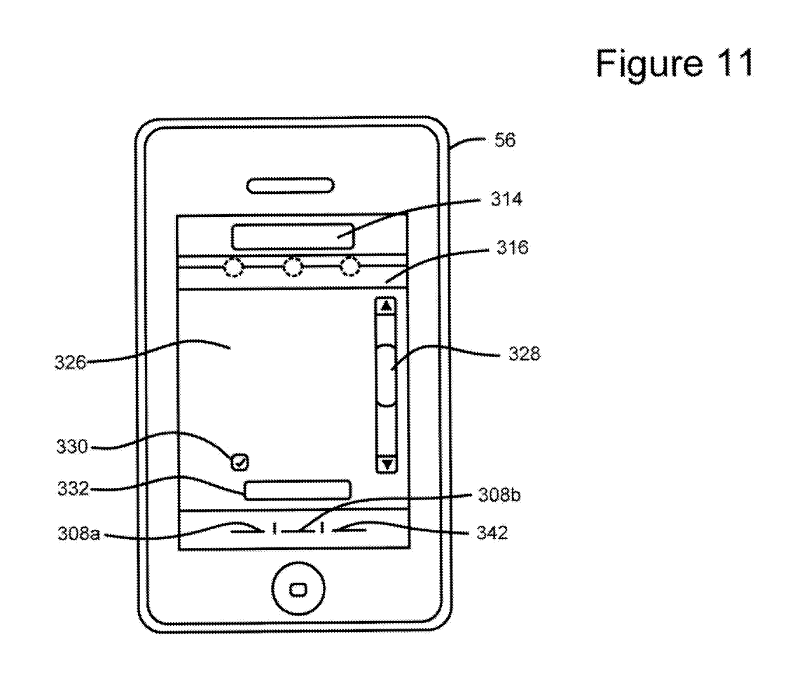

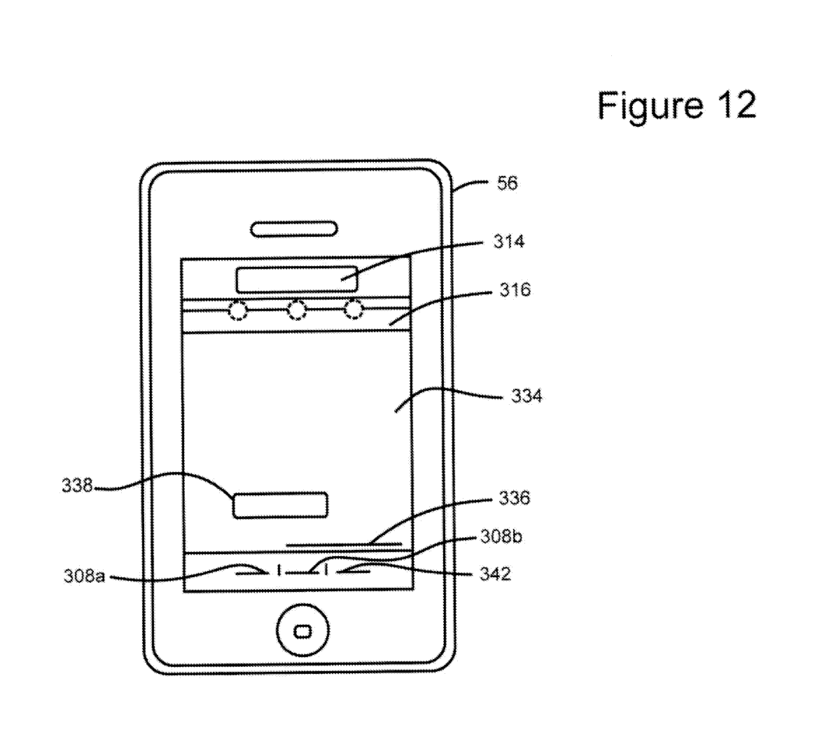

FIG. 11 illustrates an embodiment of the graphical user interface for step 110. Screen 326 displays the terms and agreements for system 50. User 58 may scroll through and read the terms and agreements. If the terms and agreements are longer than the display space, system 50 will display scroll bar 328 for screen navigation. Once user 58 has read the terms and agreements, user 58 will indicate that he agrees to the terms and agreements by selecting the button 330 and clicking button 332. System 50 will then proceed to step 116 and display confirmation screen 334 as illustrated in FIG. 12. If user 58 does not receive the confirmation email sent by system 50, user 58 may select link 336. If user 58 has received the confirmation email, user 58 may click link 338 to sign in to system 50.

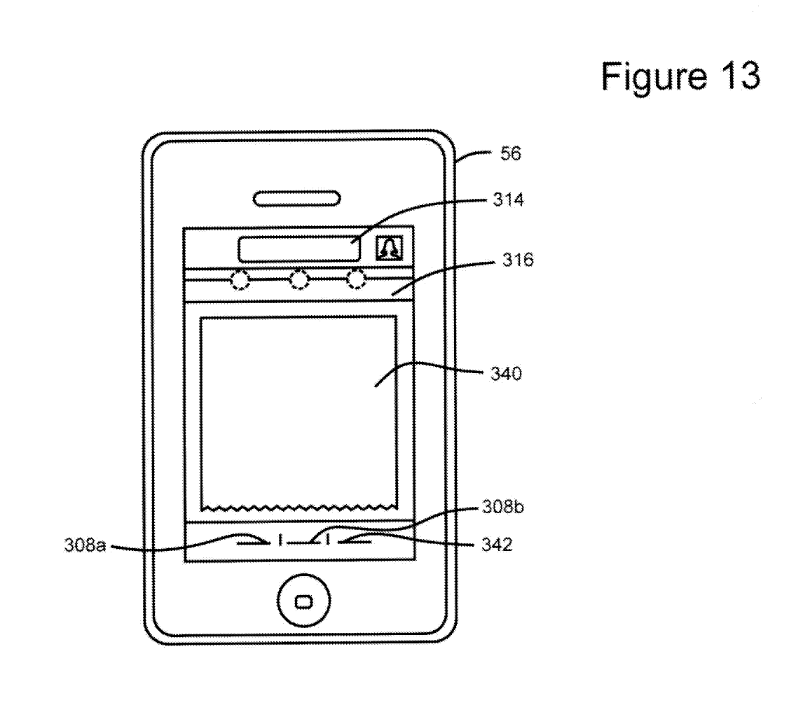

FIG. 13 illustrates an embodiment of about screen 340, which will display if user 58 clicks link 308a. About screen 340 will display a summary of system 50. FIGS. 9-13 also contain link 342, which will allow user 58 to logout of system 50 at any point.

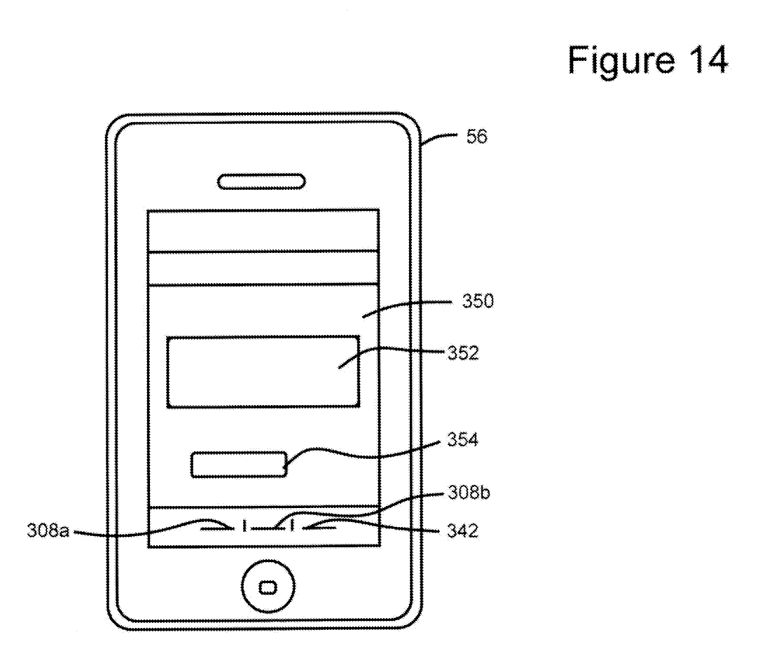

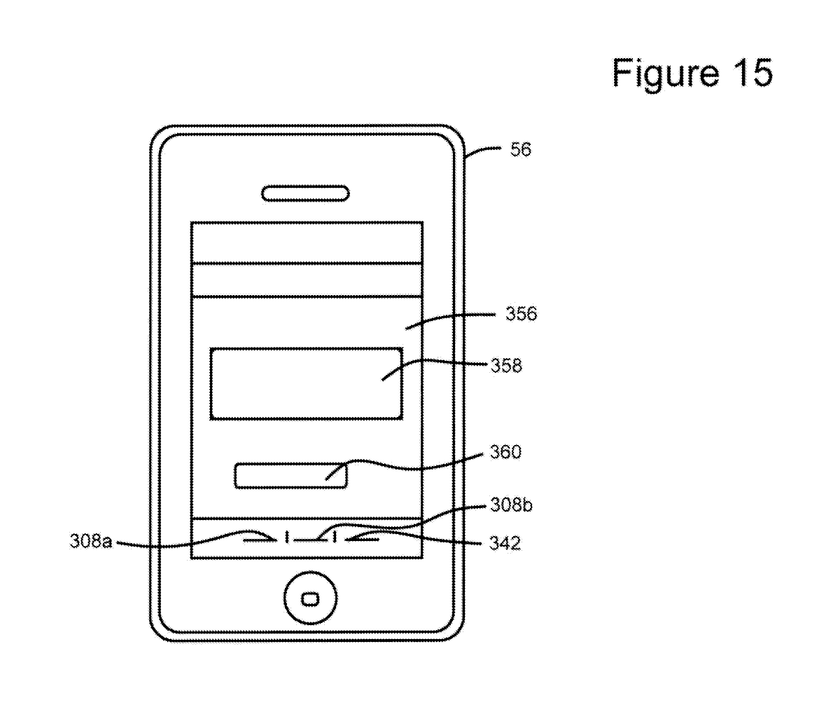

FIGS. 14-23 generally relate to system 50 as illustrated and described above for FIGS. 3-4. FIG. 14 illustrates an embodiment of the graphical user interface for step 150. Screen 350 will display a service list 352. Service list 352 will list all the services offered by system 50. User 58 will select from service list 352, the service which he/she would like to use. For example, if user 58 is looking to sell his/her home, user 58 would select “Sell a Property”. User 58 would then click link 354 and system 50 would proceed to step 152. FIG. 15 illustrates an embodiment of the graphical user interface for step 170, which is substantially the same as step 150, except for service professionals. If user 58 is a service professional, system 50 will display screen 356 instead of screen 350. Screen 356 will display service professional list 358, which will contain a list of all services which system 50 supports for service professionals. For example, if user 58 is a real estate service professional and they are representing a customer who wants to sell their home, user 58 would select “Represent a Seller” from service professional list 358. User 58 would then click button 360 and system 50 would proceed to step 152.

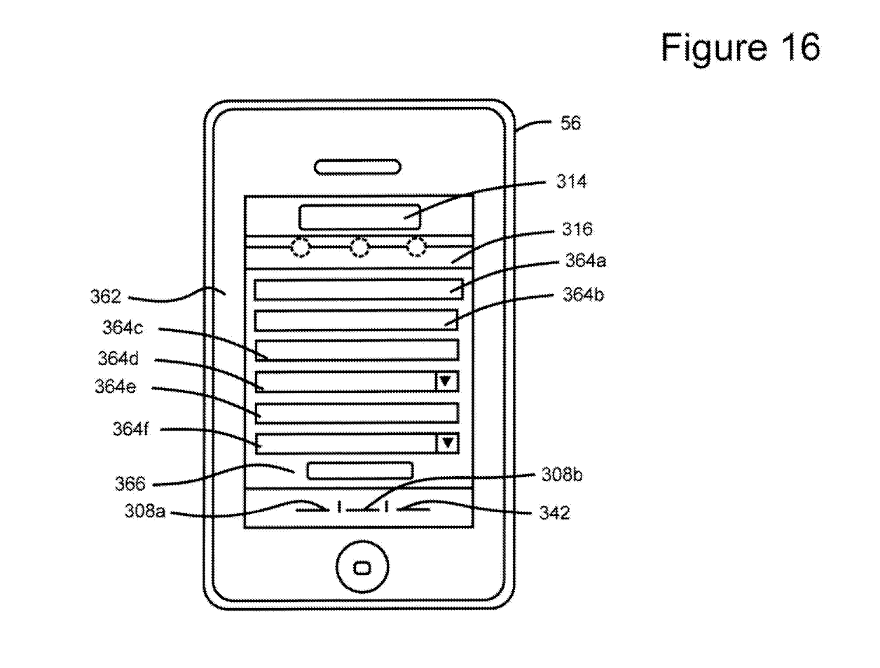

FIG. 16 illustrates an embodiment of the graphical user interface for step 152. User 58 will enter his/her service needs on screen 362, by filling in text boxes 364. For example, if user 58 is selling his or her home, user 58 would input the property information into text boxes 364a-f. Once user 58 has entered his/her service needs, user 58 will click submit button 366 and system 50 will proceed to step 154.

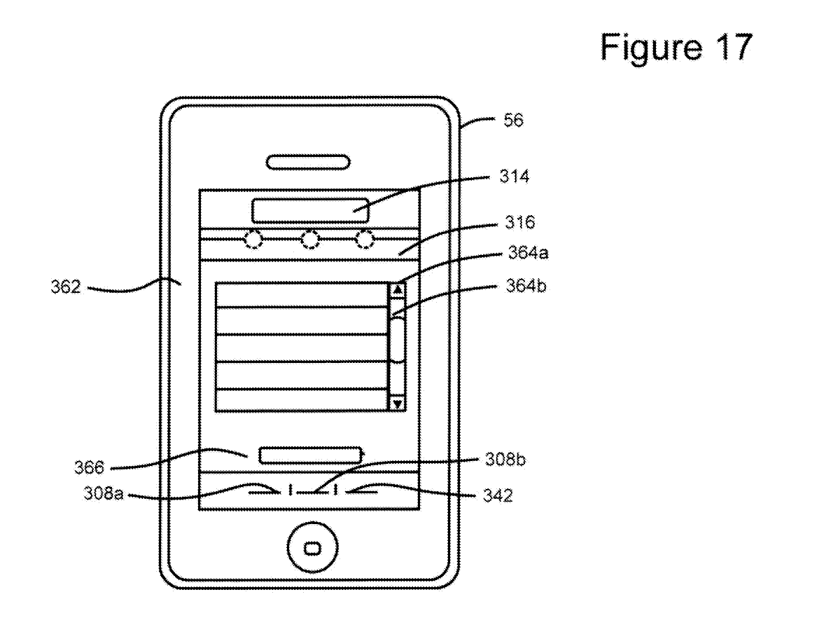

FIG. 17 illustrates an embodiment of the graphical user interface for step 154. Screen 368 will display service professional list 370 to user 58. Service professional list 370 will contain the names of all service professionals for the selected service within the area of user 58. The area will depend on the type of service desired and thus may be as small as the same town or as large as the same state. If service professional list 370 is too large for screen 368, system 50 will display scroll bar 372 for navigation. Alternatively, user 58 may use search box 374 to search for a specific service professional known to them. Also, if user 58 does not find the specific service professional they wish to use, user 58 may click on link 376 to invite that service professional to use system 50. If user 58 finds a desired service professional on service professional list 370, they may select the desired service professional and click submit button 378 and system 50 will proceed to step 164.

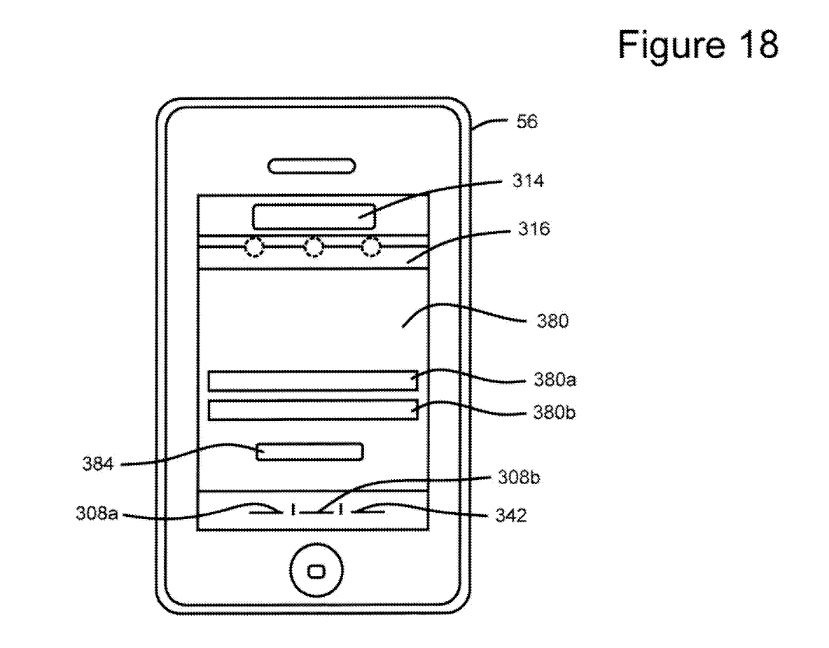

FIG. 18 illustrates an embodiment of the graphical user interface for step 160. If user 58 has clicked link 376 to invite a specific service professional system 50 will display screen 380. User 58 enters the service professional's name and contact information into texts field 382a-b, and clicks submit button 384.

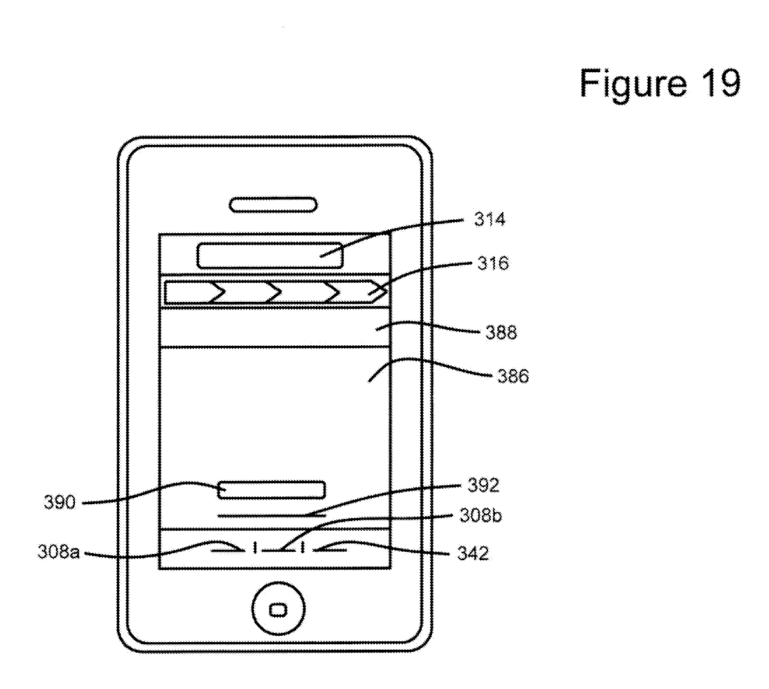

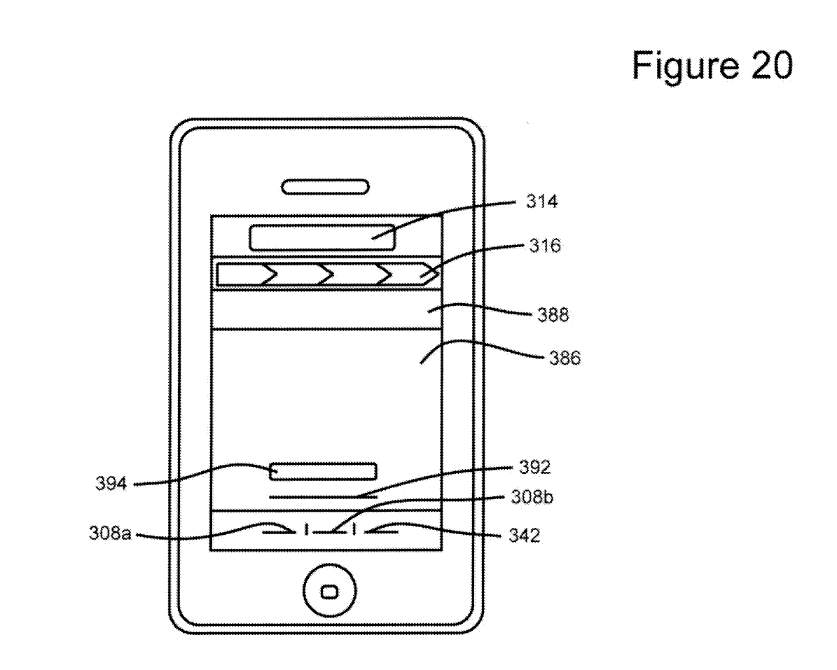

FIG. 19 illustrates an embodiment of the graphical user interface for step 164. Once user has selected a service professional at step 158, system 50 will proceed to step 164 and present user 58 with service professional interview questions. Screen 386 will display a question which user 58 may ask to the selected service professional. Screen 386 contains field 388, which will indicate the total number of questions user 58 will be presented with and the number of the current question user 58 is viewing. User 58 may select link 392, which will display a screen explaining why the question is important. Once user 58 is done with the question displayed on screen 386, user 58 clicks link 390 and system 50 will display the next question. FIG. 20 illustrates screen 386 displaying the last service professional interview question. Once user 58 has asked all the interview questions, user 58 selects button 394 and system 50 will proceed to step 166.

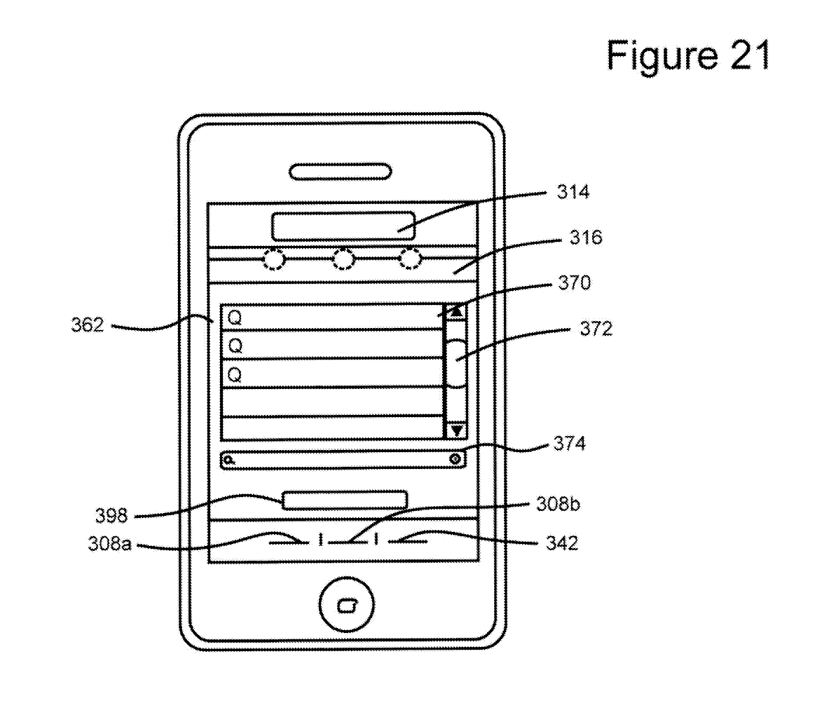

FIG. 21 illustrates an embodiment of the graphical user interface for step 166. Screen 396 will display service professional list 370, which is the same as presented on screen 368 in FIG. 17. User 58 will then make their final service professional selection on screen 396 and click button 398. Once user 58 has selected his/her desired service professional and clicked button 398, system 50 will proceed to step 168.

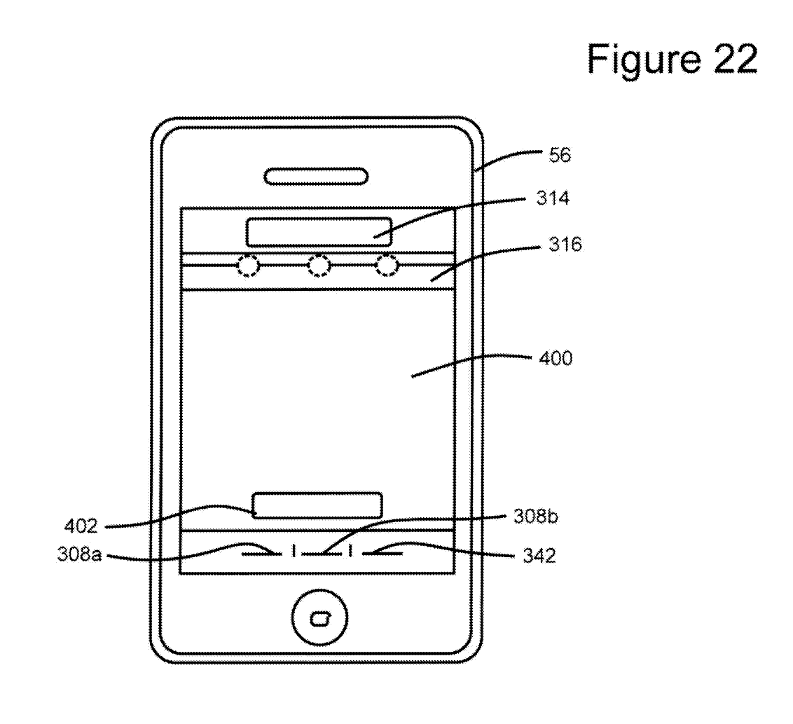

FIG. 22 illustrates an embodiment of the graphical user interface for step 168. At step 168, system 50 confirms the service professional selection of user 58. FIG. 22 illustrates confirmation screen 400, which will display a message to user 58 confirming his/her service professional selection. User 58 will then click link 402 to get started and system 50 will proceed to step 204.

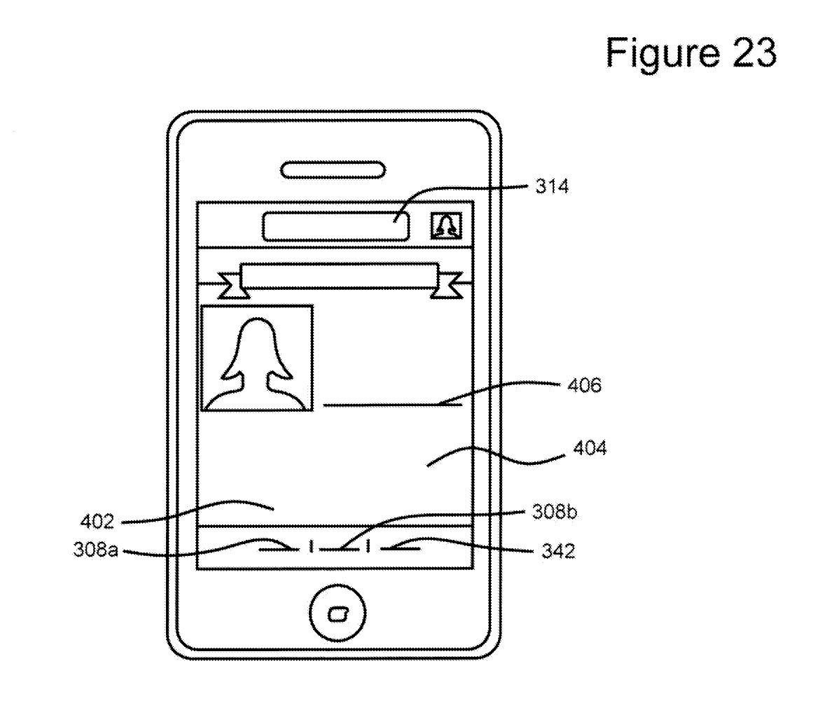

FIG. 23 illustrates an embodiment of the graphical user interface of service professional biography screen 404. Service professional biography screen 404 will display a service professional's information. The information included on service professional biography screen 404 may include the service professional's name and contact information, as well as a picture of the service professional and the grades the service professionals overall grade and the number of transactions the service professional has on system 50. Service professional biography screen 404 may contain a link 406, which will take user 58 to an explanation of how system 50 grades service professionals.

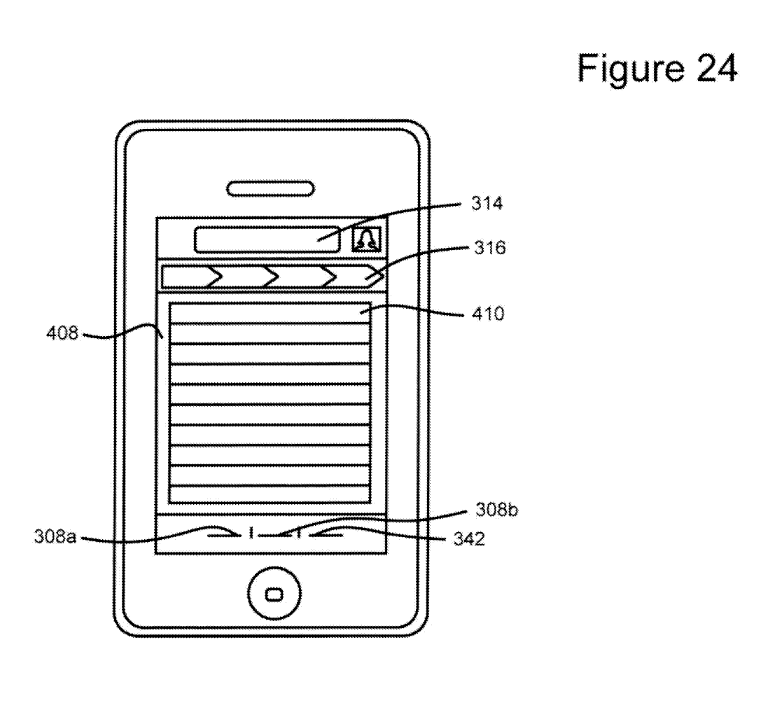

FIG. 24-30 generally relate to system 50 as illustrated and described above for FIG. 5. FIG. 24 illustrates an embodiment of the graphical user interface for step 204. FIG. 24 illustrates sub-menu screen 408, which displays sub-menu 410. Sub-menu 410 will contain a selectable list of all the steps associated with the selected service. For example, if user 58 is selling his/her home, sub-menu 410 may contain the following list: 1) listing agreement; 2) preparation; 3) marketing (broker); 4) marketing (consumer); 5) showings; 6) offers; 7) negotiations; 8) contracts; 9) closing; and 10) after the sale.

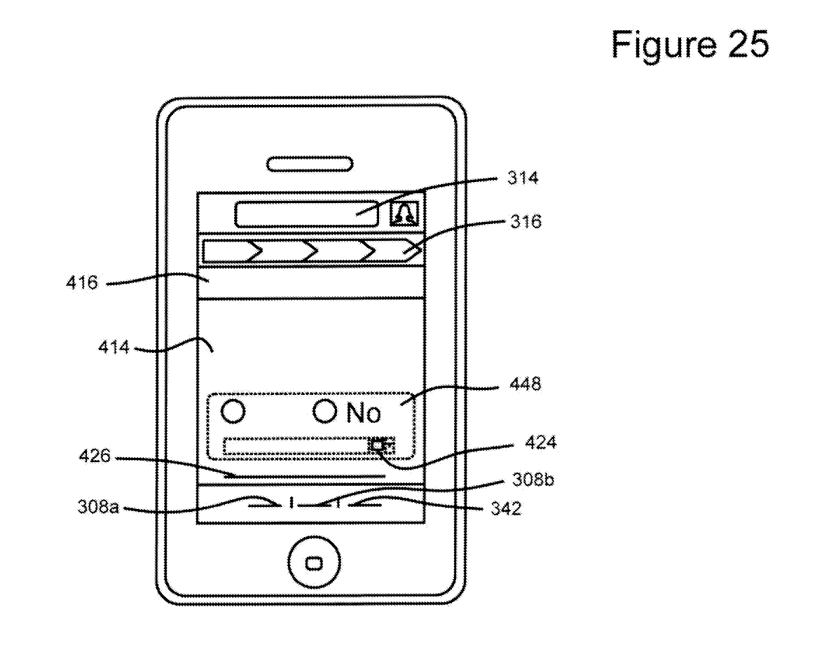

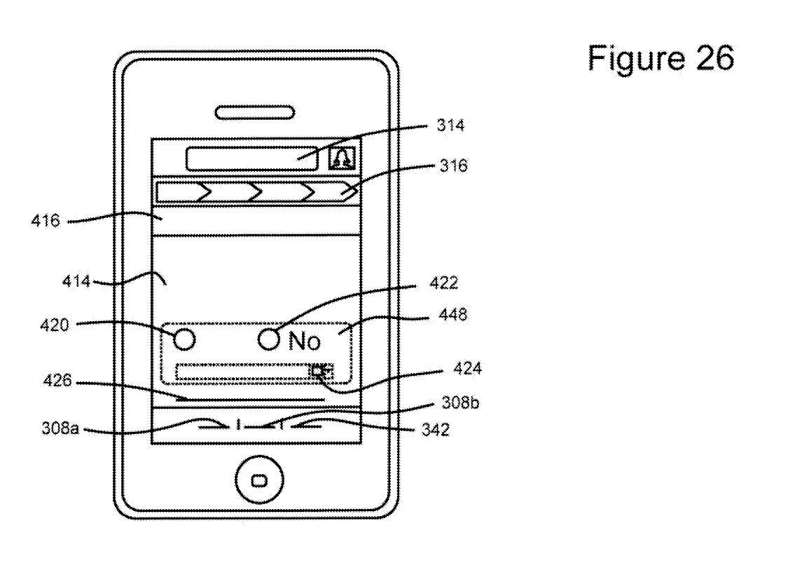

If user 58 selects a step listed in submenu 410 at step 206, the system proceeds to step 208. FIG. 25 illustrates an embodiment of the graphical user interface for steps 208-214. FIG. 25 illustrates step screen 414, which will display a yes/no question about the selected sub-menu step. Step screen 414 will also contain field 416, which will display the service professional's overall grade, current sub-menu grade, the number of yes/no questions to be asked, and the number of the current yes/no question. Step screen 414 will contain answer box 418. Answer box 418 contains “yes” button 420, “no” button 422, and date box 424. User 58 will be able to answer the question displayed on screen 414 by selecting “yes” button 420 or “no” button 422. If user selects “yes” button 420, user 58 would then indicate the date the question was completed in date box 424. Step screen 414 also contains link 426, which will display a screen detailing why the displayed question is important. Once user has selected either “yes” button 420 or “no” button 422, system 50 will proceed to step 220, which is just the next question as illustrated in FIG. 26.

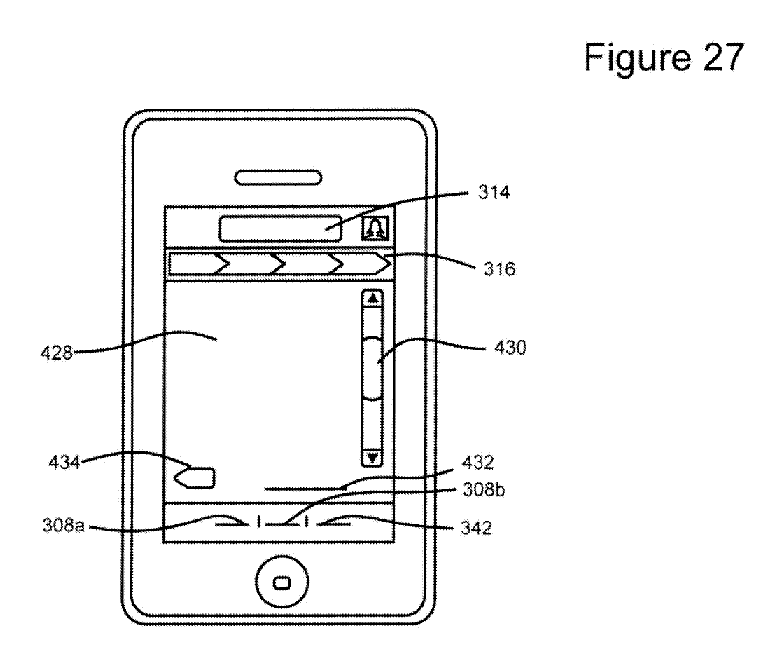

FIG. 27 illustrates an embodiment of the graphical user interface for step 228 and the screen that system 50 displays if user clicks link 426. FIG. 27 illustrates explanation screen 428, which details why a specific question or step is important for the service being performed by the service professional. If the explanation is too long to be displayed, system 50 may provide scroll bar 430 for navigation. Explanation screen 428 may also contain link 432 which will display even more information regarding the step in the process. Explanation screen 428 contain link 434, while allows user 58 to navigate back to the previous screen.

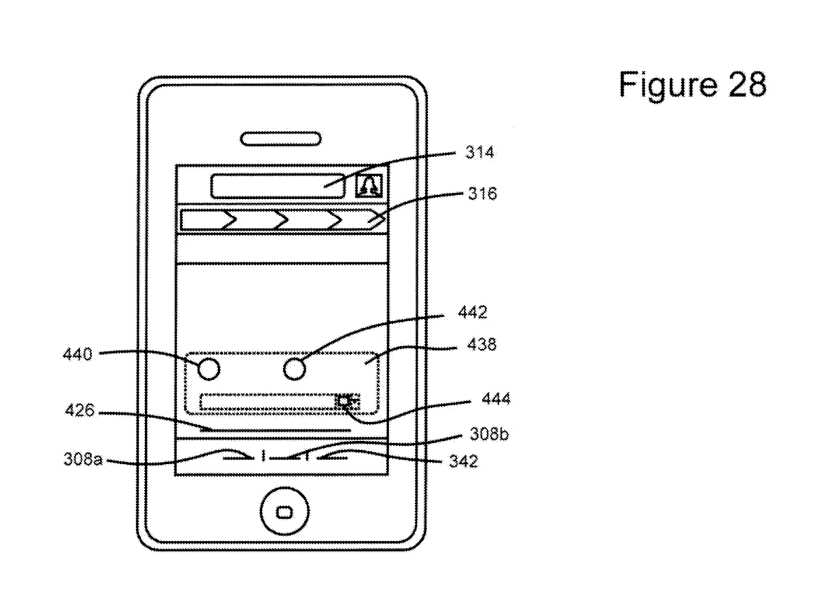

FIG. 28 illustrates an embodiment of the graphical user interface for step 210-218. If user 58 indicates at step 210 that the service professional did not complete a step, system 50 will provide user 58 with an opportunity to override the step if there is an acceptable explanation at step 216. FIG. 28 illustrates override screen 436. Override screen 436 will ask user 58 if he/she wishes to override the particular step. Override screen 436 will contain answer box 438. Answer box 438 contains “yes” button 440, “no” button 442, and date box 424. User 58 will be able to answer the question displayed on override screen 414 by selecting “yes” button 440 or “no” button 442. If user selects “yes” button 440, user 58 would then indicate the date the question was completed in date box 444. Override screen 436 also contains link 426, which will display a screen detailing why the displayed question is important. Once user has selected either “yes” button 440 or “no” button 442, system 50 will proceed to step 220, which is just the next question as illustrated in FIG. 26.

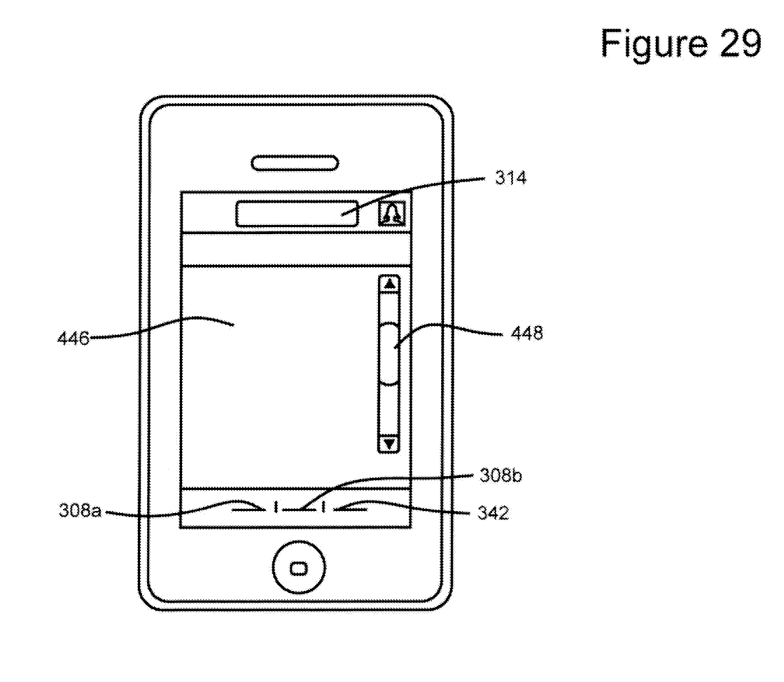

FIGS. 29-32 generally relate to system 50 as illustrated and described above for FIG. 6. FIG. 29 illustrates an embodiment of the graphical user interface if user 58 clicks link 406 as described above for FIG. 23. FIG. 29 illustrates grade explanation screen 446, which contains a detailed explanation of how system 50 grades service professionals. If the explanation is too long for display on computer device 56, system 50 will provide scroll bar 448 for navigation.

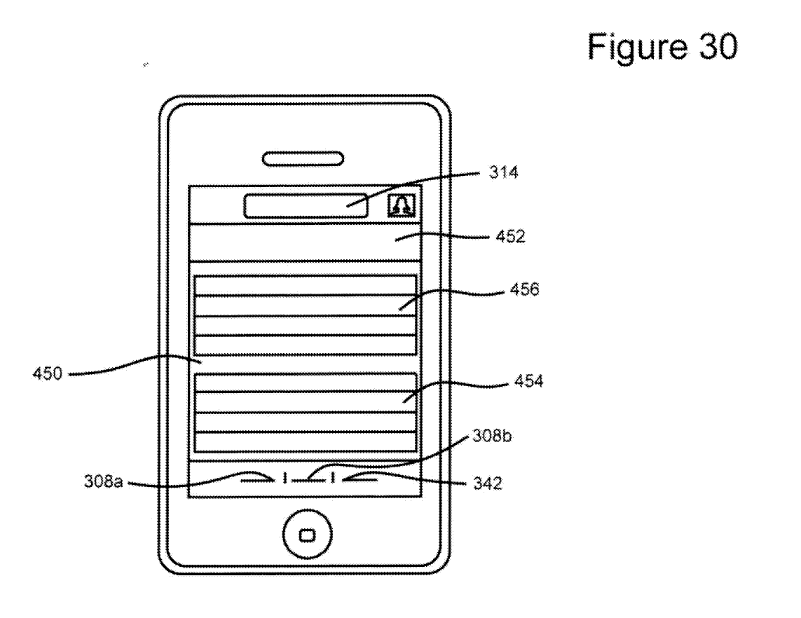

FIG. 30 illustrates an embodiment of the graphical user interface if user 58 clicks on a service professional's graded transactions on the service professional's biography page as illustrated above in FIG. 23. FIG. 30 illustrates grade detail screen 450. Grade detail screen 450 contains summary field 452, which displays the name of the service professional, the service professional's overall grade, and the number of transactions the service professional has on-going and/or completed on system 50. Grade detail screen also contains progress box 456, which displays all on-going transactions for the selected service professional along with the current step and current grade for each on-going transaction. Grade detail screen 450 also contains completed box 454, which displays all completed transactions for the selected service professional and the grade achieved for each completed transaction.

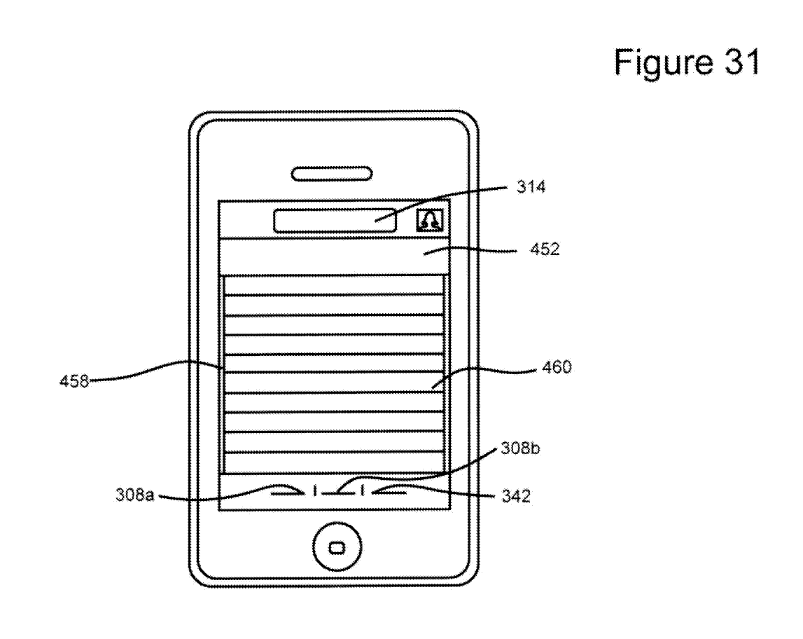

FIG. 31 illustrates an embodiment of the graphical user interface if user 58 clicks on a service professional's overall grade on the service professional's biography page as illustrated above in FIG. 23. FIG. 31 illustrates overall grade detail screen 458. Overall grade detail screen 458 contains grade screen 460, which lists the service professional's grade for each step in a transaction. For example, if the service professional is a real estate agent and user 58 is using him/her for selling a home, the listed steps will be: 1) listing agreement; 2) preparation; 3) marketing (broker); 4) marketing (consumer); 5) showings; 6) offers; 7) negotiations; 8) contracts; 9) closing; and 10) after the sale. Next to each step in grade screen 460 will be the average grade the service professional has achieved for each step over all completed transactions.

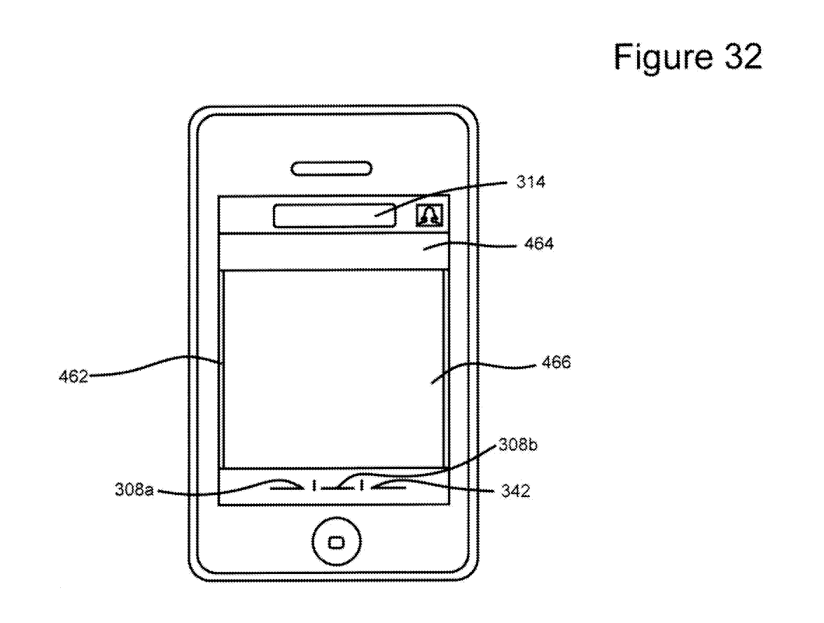

FIG. 32 illustrates an embodiment of the graphical user interface of a progress report for any given on-going service transaction. FIG. 32 illustrates progress screen 462, which contains progress detail box 466. Progress detail box 466 will contain a list of all steps needed to complete the current on-going transaction, and will indicate which of those steps have been completed along with the grade achieved, and the steps to-be completed. Progress screen 462 may also contain summary field 464, which may contain the service professional's name, current transaction grade, and the current step the service professional is on along with the total number of steps.

In yet another embodiment of the present inventive system, system 50 may be used by service professional managers and/or the company a service professional works for to track a service professional's performance. Thus, a manager or company will be able to better understand the abilities of employees and how they are performing, which in turn may lead to additional education, mentoring, or support from the service professional managers/company.

In an alternative embodiment of the present inventive system, system 50 may generate a dashboard for service professional managers and/or the companies. The dashboard will enable a service professional manager and/or the company to get an overall look at all their employees and how they are progressing. System 50 may generate a company-wide average grade by averaging all of a company's service professionals' grades, both overall grades and transactional step grades. Further system 50 will allow a service professional manager and/or the company to see if their employees are complying with the industry best standards and practices and where their employees need help.

In accordance with a particularly preferred embodiment of the invention, the consumer can do this by requiring their service provider to follow the steps and actions the system has recommended and then by suggesting (requiring) their service provider to subscribe to the system in return for securing the consumers' business. By consumers informing their chosen service provider that they are being guided by the system and implying, suggesting or requiring that, as a condition of being hired, they should subscribe to the inventive system, the inventive system hopes to enlist the support of consumers in acquiring paying service provider customers. This is in addition to other marketing methods.

Once a service provider becomes a the inventive system subscriber, the service provider will be able to access the consumer's account (at the consumer's invitation) and begin their accountability and grading. Specifically, at each step the inventive system asks the service provider if they have done a particular action, often (but not always) within a specified time. When each action under each step is performed by the service provider, the service provider logs into the consumer's account on their smart phone or computer and checks a “yes” or “no” box next to each action, indicating whether they did or did not perform that action. At the time of setting up their account, consumers are asked by the inventive system how often they wish to be emailed regarding specific actions, i.e. (1) when each is completed, or (2) weekly, or (3) when an update is provided by the service provider. The consumer then is notified by email of the time and date the action was completed.

If the service provider did not perform the action within the the inventive system specified time, the inventive system will so inform the consumer. Alternatively, a service provider can decline to perform the action and so indicate. When they do, a pop up text box asks them to explain why. That explanation is immediately emailed to the consumer. If the consumer agrees with the service provider's rationale, they check a box saying “I agree” and the inventive system will either eliminate the action from the step or give the service provider additional time to perform the action with “no” detriment to the service provider's weighted points or grade.

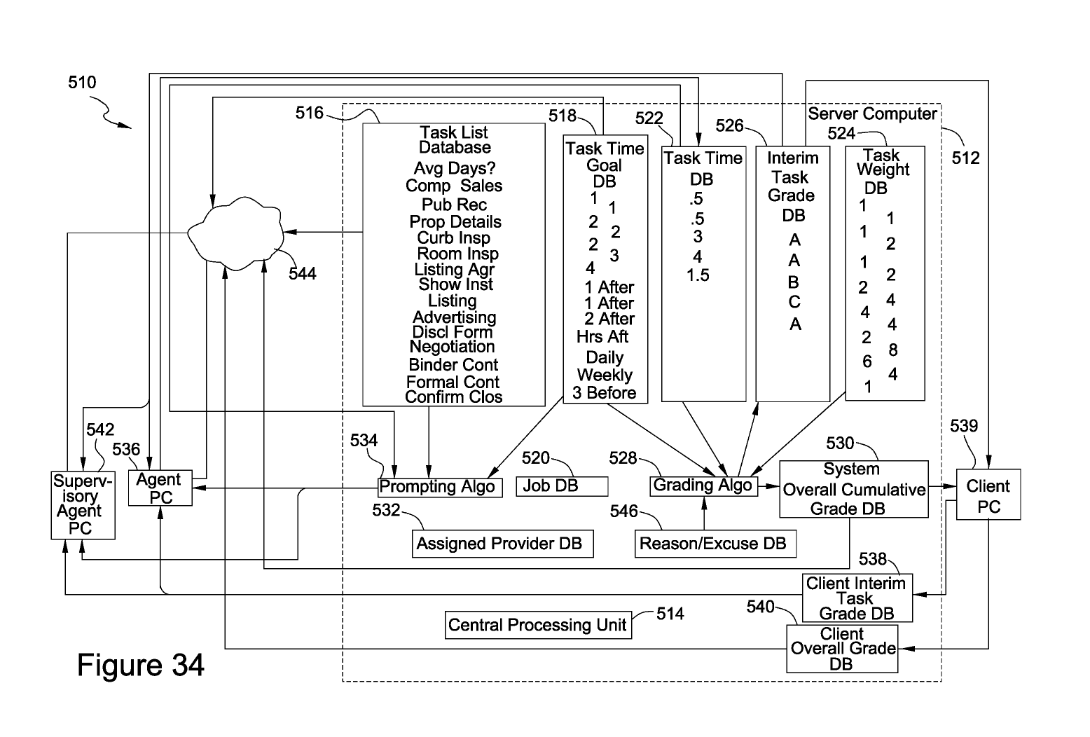

The inventive apparatus may be further understood with reference to FIG. 34, which, for illustrative purposes, illustrates the invention in connection with the real estate sales business. More particularly, in accordance with the embodiment of FIG. 34, apparatus 510 for regulating the quality of service providers, rating agents, reviewing agents, supervising agents and educating consumers thus facilitating efficient and quality delivery of services by providers, centers on a server computer 512 comprising a processing unit 514. Server computer 512 comprises a computer-readable medium which stores a task database 516 listing a plurality of tasks associated with performance of a job, a time goal database 518 listing goal completion time data for at least a first portion of the tasks, a job database 520 listing a plurality of jobs, an actual task time database 522 listing, for each job, actual time taken to perform each of said tasks in said first portion of the tasks, a task weight database 524 listing a numerical value indicative of the importance to be accorded to each of said tasks in said first portion of the tasks, an interim task grade database 526 listing, for each job, grades associated with at least a subset portion of the tasks in said first portion of the tasks, and a grading algorithm 528 responsive to information in said time goal database to generate interim grades which are stored in interim task grade database 526. The actual task time database 522 and the task weight database 524, together with the task time goal database 518 drive the grading algorithm to generate cumulative grades which are stored in a system overall cumulative grade database 530. The database structure of server computer 512 further comprises an assigned provider database 532 listing a provider for each job.

As can be seen in FIG. 34, a typical task, such as determining the average days on the market is given a goal, for example one day measured from the date that the record is opened. Likewise, finding comparable sales is scheduled to be done during the first day. Obtaining the public record, property details the curbside inspection are all scheduled for completion before the end of the second day from the opening of the record. An inspection of the inside of the house is scheduled for completion by the end of the third day, and the presentation of a listing agreement to the client is scheduled for the fourth day. The first two tasks are completed within one half a day and therefore received an “A” grade. Obtaining the public wreckage was obtained, any example, a little late, so it received a “B” grade. Each of these tasks is then weighted to obtain an average weighted grade in conventional fashion.

The computer-readable medium which forms a memory of server computer 512 stores a prompting algorithm 534 responsive to information in the task database 516, the time goal database 518 and the actual task time database 522 to generate task prompting messages and communicate to a respective provider personal computing device 536. The prompts contain information respecting tasks to be performed in connection with a particular job.

A plurality of provider personal computing devices 538 are each associated with a provider and with one or more jobs in the job database 520. The prompting algorithm 534 causes the transmission of prompts to the provider personal computing device associated with the task to be performed in connection with each particular job. The provider personal computing devices are adapted to send task time completion data to the actual task time database 522. Provider personal computing devices may be personal computers, smartphones, or any other device providing input and output interfaces, connectivity to the Internet and at least basic processing functions. Information in the will interim task grade database relating to a particular job is sent to the personal computing device associated with the provider assigned to said particular job.

In accordance with the invention, the system may accommodate a plurality of clients by providing a plurality of client personal computing devices 539, which may be personal computers, smart phones, or any other device with connectivity, such as an iPod computing device, and iPad computing device, or various Android tablets and mini-tablets. Each of said client personal computing devices being associated with a job for a particular client, said server computer hosting software causing the transmission of interim task grade database information for a particular job to the client personal computing device associated with said particular job.

The grading algorithm 526 is, upon job completion, responsive to the task weight database 524 and the interim task grade database 526 to generate a system overall cumulative grade and store the same in a system overall cumulative grade database 530.

In accordance with the invention, the system may further include an excuse database 546_listing acceptable excuses for delays in task time completion, and wherein the grading algorithm 528 is responsive to excuse database 546 to increase a grade where an excuse is listed.

In the embodiment of the invention illustrated in FIG. 34, the computable-readable medium stores a client interim task grade for each particular job which is communicated by the computer server to the personal computing device of the provider associated with that particular job.

Optionally, the computer-readable medium may include a client interim task grade database 538 responsive to a client personal computing device to receive and store a subjective client grade for overall tasks. These interim task grades may be weighted and averaged to calculate an overall cumulative subjective client grade for storage in a client overall grade alternatively, the client may directly enter an subject to overall cumulative grade directly into database 540, as illustrated. Interim task grades may be communicated to the service provider to provide feedback and the opportunity to take corrective action.

Optionally, the server is programmed to communicate information on said interim task grade database, and information from said client interim task grade database to a supervisory provider personal computing device 542. Likewise, in accordance with the invention, the server computer is optionally programmed to communicate the prompts to the supervisory provider personal computing device 542.

In accordance with the invention, it is contemplated that the public may receive educational information by being given access to task database 516 and time goal database 518. Likewise, optionally, the objective system overall cumulative grade database 530 and the subject of grades in the client overall grade database 540 may be made available on the Internet as a tool for allowing consumers to judge the quality of services provided by a particular service provider. In this respect, the provision of objective criteria defined by industry best practices in the opinion of those at the highest level in the industry provides a marked difference with respect to conventional rating systems which are subjective and are given after the fact. In contrast, the present invention features both interim objective and subjective task scoring as well as final objective and subjective job scoring. Any selection of this information may be made available publicly on the Internet 544 for the purpose of guiding consumers. Likewise, any selection of this information may be made privately available, for example, for the purpose of guiding service providers and their supervisors.

While illustrative embodiments of the invention have been described, it is noted that various modifications will be apparent to those of ordinary skill in the art in view of the above description and drawings. Such modifications are within the scope of the invention that is limited and defined only by the following claims.

What is claimed:

1. Apparatus for facilitating efficient and quality delivery of services by providers, comprising:
(a) a server comprising a processing unit;
(b) a computer-readable medium storing:
(i) a task database listing a plurality of tasks associated with performance of a job,
(ii) a time goal database listing goal completion time data for at least a first portion of the tasks,
(iii) a job database listing a plurality of jobs,
(iv) an actual task time database listing, for each job, actual time taken to perform each of said tasks in said first portion of the tasks,
(v) a task weight database listing a numerical value indicative of the importance to be accorded to each of said tasks in said first portion of the tasks,
(vi) an interim task grade database listing, for each job, grades associated with at least a subset portion of the tasks in said first portion of the tasks,
(vii) a grading algorithm responsive to information in said time goal database, said actual task time database and said task weight database, said grading algorithm generating interim grades and storing said interim grades in said interim task grade database, said interim grades being based on listings in said task time goal database and said actual last time database,
(viii) an assigned provider database listing a provider for each job, and
(ix) a prompting algorithm responsive to said time goal database and said task database to generate prompts containing information respecting tasks to be performed in connection with a particular job;
(c) a plurality of provider personal computing devices, each of said provider personal computing devices being associated with a provider associated in said assigned provider database with a job in said job database, said prompting algorithm causing the transmission of prompts to the provider personal computing device associated with the task to be performed in connection with a particular job, and said provider personal computing devices being adapted to send task time completion data to said actual task time database; and
(d) a plurality of client personal computing devices, each of said client personal computing devices being associated with a job for a particular client, said server computer hosting software causing the transmission of interim task grade database information for a particular job to the client personal computing device associated with said particular job.

2. Apparatus as in claim 1, wherein the grading algorithm is, upon job completion, responsive to the task weight database and the interim task grade database to generate a system overall cumulative grade and store the same in a system overall cumulative grade database.

3. Apparatus as in claim 1, wherein the personal computing devices are handheld devices.

4. Apparatus as in claim 1, wherein information in said interim task grade database relating to a particular job is sent to the personal computing device associated with the provider assigned to said particular job.

5. Apparatus as in claim 1, wherein said computer-readable medium stores a excuse database listing excuses for delays in task time completion, and where in said grading algorithm is responsive to said excuse database to increase a grade where an excuse is listed.

6. Apparatus as in claim 1, wherein said computable-readable medium stores a client interim task grade and said client interim task grade for a particular job is communicated by said computer server to the personal computing device of the provider associated with said particular job.

7. Apparatus as in claim 1, wherein said computer-readable medium is responsive to a client personal computing device to receive and store a subjective client overall grade in a client overall grade database.

8. Apparatus as in claim 1, further comprising a supervisory provider personal computing device and wherein said server is programmed to communicate information on said interim task grade database, and information from said client interim task grade database to said supervisory provider personal computing device.

9. Apparatus as in claim 8, wherein said server computer is programmed to communicate said prompts to said supervisory provider personal computing device.

10. Apparatus as in claim 6 wherein said task database, said time goal database, said system overall cumulative grade database is made available on the Internet.

11. Apparatus as in claim 10, wherein said client overall grade database is made available on the Internet.

12. Apparatus for regulating the quality of service providers, rating agents and managers, comprising:
(a) a server comprising a processing unit;
(b) a computer-readable medium storing:
(i) a task database listing a plurality of tasks associated with performance of a job,
(ii) a time goal database listing goal completion time data for at least a first portion of the tasks,
(iii) a job database listing a plurality of jobs,
(iv) an actual task time database listing, for each job, actual time taken to perform each of said tasks in said first portion of the tasks,
(v) a grading algorithm responsive to information in said time goal database and said actual task time database generating interim grades and storing said interim grades in an interim task grade database,
(vi) an assigned provider database listing a provider for each job; and
(vii) a prompting algorithm responsive to said time goal database, said task database and said task time database to generate prompts containing information respecting tasks to be performed in connection with a particular job;
(c) a plurality of provider personal computing devices, each of said provider personal computing devices being associated with a provider associated in said assigned provider database with a job in said job database, said prompting algorithm causing the transmission of prompts to the provider personal computing device associated with the task to be performed in connection with a particular job, and said provider personal computing devices being adapted to send task time completion data to said actual task time database; and
(d) a plurality of client personal computing devices, each of said client personal computing devices being associated with a job for a particular client, said server computer hosting software causing the transmission of interim task grade database information for a particular job to the client personal computing device associated with said particular job.

13. Apparatus as in claim 12, wherein said computer-readable medium stores a excuse database listing excuses for delays in task time completion, and where in said grading algorithm is responsive to said excuse database to increase a grade where an excuse is listed.

14. Apparatus as in claim 12, wherein said computable-readable medium stores a client interim task grade and said client interim task grade for a particular job is communicated by said computer server to the personal computing device of the provider associated with said particular job.

15. Apparatus as in claim 12, wherein said computer-readable medium is responsive to a client personal computing device to receive and store a subjective client overall grade in a client overall grade database.

16. Apparatus as in claim 12, further comprising a supervisory provider personal computing device and wherein said server is programmed to communicate information on said interim task grade database, and information from said client interim task grade database to said supervisory provider personal computing device.

17. Apparatus as in claim 16, wherein said server computer is programmed to communicate said prompts to said supervisory provider personal computing device.

18. Apparatus as in claim 14 wherein said task database, said time goal database, said system overall cumulative grade database is made available on the Internet.

19. Apparatus as in claim 18, wherein said client overall grade database is made available on the Internet.
